(19) United States
(12) Patent Application Publication
(10) Pub. No.: US 2026/0261425 A1
(43) Pub. Date: Sep. 3, 2026

(54) Behavioral Economical Identity (BEI) Currency System and Sovereign Index Network

(71) Applicant: FURONG BEI, SAN GABRIEL, CA (US)

(72) Inventor: FURONG BEI, SAN GABRIEL, CA (US)

(21) Appl. No.: 19/177,572

(22) Filed: Apr. 13, 2025

(51) Int. Cl. H04L 9/32; H04L 9/08

(52) U.S. Cl. CPC H04L 9/3236; H04L 9/0866; H04L 9/3213; H04L 9/3247

(57) ABSTRACT

An identity-bound behavioral asset system converts verified behavioral events into auditable tokenized assets. A behavioral event interface receives an event object including a timestamp, time-window identifier, behavior category, consent scope, and evidence commitment. A TransferKey software development kit generates a cryptographic signature hash using a user identity key associated with a domain identifier. An Admission Gate validates nonce uniqueness, issuer authorization, consent, policy version, and time-window eligibility. An encrypted behavioral vault stores an encrypted payload or commitment and returns a vault identifier and receipt hash. A BEI index snapshot engine generates a signed snapshot from the signature hash, vault identifier, behavior category, policy version, and time window. A minting engine records token metadata and a mint transaction hash only when the gate pass state, vault receipt, snapshot, and domain route are jointly verified. A routing engine sends the asset to exchange, time-bank, governance, or clearing endpoints.

### CROSS-REFERENCE AND CONTINUITY STATEMENT

This disclosure relates to a Behavioral Economics Identity currency system and sovereign index network for converting verified behavioral events into auditable behavioral digital assets through a specific ordered technical pipeline. The disclosure may be used with related BEI, BEIMINT, BEIINDEX, BEIWALLET, BEI-CX, BEIGX, BEISX, ATMS, 24HWS, domain-identity, time-bank, and clearing infrastructures, without limiting the invention to any particular commercial mark, domain string, corporation, jurisdiction, chain, token standard, or user interface.

Where a commercial name, domain name, protocol prefix, or product name is referenced, the reference identifies a non-limiting implementation example. Operative scope is defined by the recited computer modules, data structures, cryptographic relationships, gate states, metadata bindings, registry permissions, and routing outputs.

The invention is directed to a behavioral asset genesis layer. In certain deployments, the generated behavioral digital assets may later be admitted to a downstream exchange, clearing, settlement-backed index, reserve, security, derivative, title, insurance, value-return, or rollback infrastructure. This disclosure focuses on the upstream formation of auditable behavioral assets and their initial index and clearing-route readiness.

### TECHNICAL FIELD

The disclosure relates to computer-implemented identity, cryptographic signing, distributed data storage, behavioral-event indexing, tokenized asset generation, domain-based endpoint routing, time-bank interoperability, exchange routing, and clearing interoperability.

More particularly, the disclosure relates to systems and methods that convert a verified behavioral event into an auditable behavioral digital asset through an ordered pipeline comprising an identity-bound TransferKey software development kit, an Admission Gate state machine, an encrypted behavioral vault, a BEI index snapshot engine, a minting engine, a domain identity registry, and an exchange or clearing routing engine.

The disclosed technology improves computer processing of behavior-derived digital assets by forcing each downstream operation to consume defined upstream identifiers and receipts. The required relationship among a signature hash, vault identifier, signed index snapshot, domain identifier, mint transaction hash, and clearing receipt hash prevents orphaned token metadata, replayed behavior events, unverifiable pricing, and untraceable settlement routing.

### BACKGROUND

Conventional loyalty, reward, activity tracking, and digital asset platforms often treat user actions as local points, account entries, or isolated tokens. Such systems may record an event or mint a digital object, but they generally fail to maintain a full chain of custody from identity-bound signing through encrypted storage, index snapshot generation, token metadata formation, domain-based routing, and clearing receipt reconciliation.

Some blockchain systems issue non-fungible tokens for activities. Some wallet systems bind users to addresses. Some index systems publish pricing or reputation scores. Some exchanges provide listing or quotation services. However, those components are typically independent and do not require that a behavioral event signature hash, a vault receipt, an index snapshot, a domain identity registry record, and a clearing route be mutually consistent before the asset is minted or routed.

A technical problem arises when behavioral data are converted into digital assets without a deterministic evidentiary path. Without a required signature hash, a minted object may not be attributable to an authorized behavior source. Without a vault identifier and receipt hash, the underlying evidence may be unavailable for audit or privacy-preserving verification. Without a signed index snapshot frozen at a policy version and time window, later pricing changes may corrupt the provenance of the asset. Without a domain identity registry, ownership, permissions, governance roles, and clearing routes may be bound only to a wallet address rather than to a broader identity namespace. Without a clearing receipt hash, the asset may be difficult to reconcile in exchange, time-bank, or settlement workflows.

A further technical problem is replay and spoofing. A behavior record can be duplicated, re-submitted outside an effective time window, signed by an unauthorized issuer, used without consent, or minted under an obsolete policy version. A conventional reward system may merely flag such conditions after the fact. The disclosed system uses an Admission Gate state machine to deny minting or route a record to quarantine before a complete token metadata object is formed.

A further technical problem is index manipulation. A behavioral event may be priced or scored using an index value that changes over time. The disclosed system generates a signed BEI index snapshot at a defined time window and policy version, then binds that snapshot into token metadata. Later exchange quotation or recalibration may occur, but the original signed snapshot remains auditable.

A further technical problem is settlement readiness. Ordinary NFTs or reward points often cannot be reconciled by a clearinghouse without reconstructing private behavior data. The disclosed token metadata and clearing receipt objects provide identifiers, hashes, policy versions, netting windows, and route states that allow settlement or reconciliation while raw behavior payloads remain encrypted or off-chain.

Accordingly, a need exists for a concrete computer-implemented pipeline that transforms a behavioral event into a tokenized behavioral asset only after identity-bound signing, Admission Gate validation, encrypted vault receipt generation, signed index snapshot formation, domain registry permission verification, and exchange or clearing route assignment.

### SUMMARY OF THE INVENTION

The invention provides an identity-bound behavioral asset system that receives a behavioral event object, generates a TransferKey signature hash, validates the event through an Admission Gate, stores an encrypted payload or commitment in a behavioral vault, generates a signed BEI index snapshot, creates token metadata binding the domain identifier, vault identifier, signature hash, index snapshot, policy version, consent scope, and mint transaction hash, and routes the asset to an exchange, time bank, governance, wallet, or clearing endpoint.

In one aspect, a behavioral event interface receives an event object comprising an event identifier, timestamp, time-window identifier, behavior category, context field, consent scope, evidence commitment, nonce, issuer identifier, and optional biometric or emotional metadata. The interface normalizes the event object into a schema that can be signed, vaulted, indexed, minted, and routed.

In another aspect, an identity-bound TransferKey software development kit generates a cryptographic signature hash over the behavioral event object using a user identity key associated with a user domain identifier. The signature hash is not merely an authentication token; it is a required upstream identifier for vaulting, index snapshot generation, mint metadata completion, and clearing reconciliation.

In another aspect, an Admission Gate state machine validates nonce uniqueness, time-window eligibility, consent scope, issuer authorization, policy-version eligibility, registry permission, source integrity, and previous consumption of the signature hash. If a validation state fails, the system issues a failure code or quarantine state instead of completing a mint transaction.

In another aspect, an encrypted behavioral vault stores an encrypted payload or evidence commitment corresponding to the behavioral event object and returns a vault identifier and receipt hash. The vault may retain private records off-chain while anchoring commitments to a tamper-evident data structure.

In another aspect, a BEI index snapshot engine generates a signed index snapshot from the signature hash, vault identifier, behavior category, time-window identifier, policy version, category weight, source score, tier factor, anomaly factor, oracle state, and policy coefficients. The snapshot is bound to the minted asset as a provenance and valuation state.

In another aspect, a minting engine creates token metadata comprising a user domain identifier, vault identifier, signature hash, signed index snapshot, policy version, consent scope, asset type, mint transaction hash, and optional clearing receipt hash. The minting engine is prevented from completing the token metadata unless the required identifiers are verified as mutually consistent, and no mint transaction hash is recorded unless an Admission Gate pass state, a vault receipt hash, a snapshot hash for the signed index snapshot, and a domain registry route permission are jointly verified under a same policy version and time-window identifier.

In another aspect, a domain identity registry maps a domain name, subdomain, decentralized domain, DID-style identifier, namespace basepoint, non-transferable identity token, or account-bound token to minting permissions, vault access permissions, governance permissions, index calibration permissions, listing permissions, time-bank permissions, and exchange or clearing route permissions.

In another aspect, an exchange or clearing routing engine routes the token metadata to an exchange endpoint, time-bank endpoint, governance endpoint, wallet endpoint, or clearing endpoint based on the signed index snapshot and registry permissions. The routing engine may generate a clearing receipt comprising a settlement batch identifier, netting window, counterparty route, clearing endpoint identifier, reconciliation hash, route status, and clearing receipt hash.

The disclosed ordered pipeline provides technical advantages including replay resistance, source spoofing resistance, vault tamper resistance, index manipulation resistance, metadata orphaning resistance, domain hijack resistance, clearing fraud resistance, privacy leakage resistance, and settlement readiness.

### DEFINITIONS AND ORGANIZING TERMS

Behavioral Event Object: a structured computer-readable object representing an observed, reported, sensed, or institutionally attested human action or condition, including at least an event identifier, timestamp, time-window identifier, behavior category, context field, consent scope, evidence commitment, nonce, policy version, and issuer identifier.

TransferKey SDK: a software development kit or equivalent software module configured to bind a user identity key and user domain identifier to a behavioral event object, generate a cryptographic signature or signature hash, and expose functions for signing, vault validation, index snapshot requests, minting requests, smart contract calls, and clearing-route validation.

Admission Gate: a validation state machine that determines whether a behavioral event object may proceed to signing, vaulting, index snapshot generation, minting, listing, routing, or clearing based on nonce uniqueness, consent, issuer authorization, policy version, time window, source integrity, registry permission, and failure-code status.

Encrypted Behavioral Vault: a storage subsystem, ledger-linked storage structure, distributed storage arrangement, encrypted database, or privacy-preserving storage layer configured to persist an encrypted behavioral payload, evidence commitment, signature hash, vault identifier, receipt hash, access policy, revocation state, and audit metadata.

Vault Receipt: a structured record returned by the encrypted behavioral vault, including a vault identifier, receipt hash, payload commitment, access policy hash, retention class, revocation state, and optional ledger or append-only log pointer.

BEI Index Snapshot: a deterministic, policy-bounded, or oracle-assisted signed output generated for a behavioral event or set of events at a defined time window and policy version, including an index version, effective time, behavior category weight, source score, tier factor, anomaly factor, oracle signature, and snapshot hash.

Domain Identity Registry: a registry mapping a user, wallet, identity anchor, domain name, subdomain, decentralized domain, namespace basepoint, account-bound token, or non-transferable identity token to minting permissions, vault access controls, governance roles, index calibration rights, time-bank routes, exchange routes, and clearing routes.

Tokenized Behavioral Asset: a token, NFT, time-denominated credit, service unit, ledger unit, account-bound unit, claim object, or settlement-recognized digital asset whose metadata binds a behavioral event commitment to a signature hash, vault identifier, domain identifier, signed index snapshot, policy version, consent scope, mint transaction hash, and optional clearing receipt hash.

Clearing Receipt: a structured record generated when a tokenized behavioral asset is listed, matched, netted, settled, reconciled, deposited, redeemed, routed to a time bank, routed to an exchange, or otherwise processed by a clearing node, including a batch identifier, netting window, counterparty route, clearing endpoint, status code, reconciliation hash, and clearing receipt hash.

Policy Bundle: a signed and versioned set of machine-readable rules defining authorized sources, eligible behavior categories, consent rules, time-window rules, rate limits, mint caps, index coefficients, domain permissions, listing restrictions, clearing routes, revocation conditions, failure codes, and emergency exceptions.

Time Window: an hour, day, week, month, year, epoch, session, validity interval, or policy-defined period used for nonce consumption, event eligibility, index snapshot formation, mint cap enforcement, routing, and clearing reconciliation.

Evidence Commitment: a hash, Merkle root, verifiable credential reference, signed attestation reference, encrypted pointer, zero-knowledge commitment, or equivalent integrity object that references underlying evidence without requiring public disclosure of the raw behavior payload.

Signature Hash: a cryptographic digest or verification output generated by the TransferKey SDK over the behavioral event object, nonce, time window, policy version, domain binding, and user identity key.

User Domain Identifier: a domain name, subdomain, namespace basepoint, decentralized name, DID-style identifier, account-bound token, non-transferable identity token, or equivalent identifier associated with a user or entity in the domain identity registry.

Failure Code: a structured code generated by the Admission Gate, TransferKey SDK, vault, index engine, minting engine, registry, exchange router, or clearing router when an event is incomplete, corrupted, replayed, unauthorized, outside a policy window, missing consent, inconsistent with a registry permission, or ineligible for routing.

Quarantine State: a non-minted or restricted state in which an event, vault record, index snapshot, token metadata, or route request is preserved for audit or review but is not allowed to become a transferable asset until a policy-defined condition is satisfied.

### BRIEF DESCRIPTION OF THE DRAWINGS

FIG. 1 illustrates an overall ordered behavioral asset pipeline from behavioral event capture to route or receipt feedback.

FIG. 2 illustrates a TransferKey identity-bound signing flow and generation of a signature hash.

FIG. 3 illustrates an Admission Gate state machine for validation, pass, failure code, and quarantine states.

FIG. 4 illustrates an encrypted behavioral vault and vault receipt relationship.

FIG. 5 illustrates a BEI index snapshot engine and signed snapshot output.

FIG. 6 illustrates a token metadata binding object for domain, vault, signature, snapshot, policy, consent, mint, and clearing fields.

FIG. 7 illustrates a domain identity registry and signed endpoint routing structure.

FIG. 8 illustrates exchange, time-bank, governance, and clearing routing workflow.

FIG. 9 illustrates a clearing receipt and reconciliation hash relationship.

FIG. 10 illustrates time-window basepoints and their relationship to replay control, index aggregation, and settlement cycles.

FIG. 11 illustrates correction-trigger, evidence-check, scope-boundary, correction-instruction, vault update, index update, and clearing update operations.

FIG. 12 illustrates field-of-use behavior categories that enter a common ordered pipeline.

FIG. 13 illustrates deployment environments including public chains, permissioned ledgers, append-only logs, encrypted databases, mobile applications, IoT devices, domain namespaces, exchange endpoints, and clearing endpoints.

FIG. 14 illustrates BEI ecosystem integration among BEIMINT, BEIINDEX, BEISX, BEICX, BEIWALLET, ATMS, time-bank, behavior vault, oracle, and clearing modules.

### DETAILED DESCRIPTION OF THE INVENTION

### I. Ordered Behavioral Asset Pipeline

Capture. The behavioral event interface receives a behavioral event object from a mobile device, web application, embedded sensor, household terminal, workplace terminal, medical system, education system, institutional source, wallet, time-bank terminal, software agent, or other authorized source. The output of the capture stage is a normalized behavioral event object containing required fields and evidence commitments.

Sign. The TransferKey SDK receives the normalized behavioral event object, validates identity state, binds the object to a user identity key and user domain identifier, consumes or generates a nonce for the relevant time window, and emits a signature hash. The output of the signing stage is a signature object containing at least a signature hash, public key identifier, domain binding hash, nonce, time-window identifier, and policy version.

Gate. The Admission Gate receives the behavioral event object and signature object and determines whether the event may proceed. The output of the gate stage is a pass state, failure code, quarantine state, or pending-review state. If the gate produces a failure or quarantine state, the minting engine is blocked.

Vault. The encrypted behavioral vault receives an approved event or commitment, stores an encrypted payload or evidence commitment, and returns a vault receipt. The output of the vault stage is a vault identifier and receipt hash that downstream modules must consume.

Index. The BEI index snapshot engine receives the signature hash, vault identifier, behavior category, time-window identifier, and policy version and computes a signed index snapshot. The output of the index stage is a snapshot object containing index version, effective time, category weight, source score, anomaly flag, oracle signature, policy version, and snapshot hash.

Mint. The minting engine receives the user domain identifier, signature hash, vault identifier, signed index snapshot, policy version, and consent scope and generates token metadata. The output of the mint stage is a token metadata object and mint transaction hash. The minting engine is prevented from completing token metadata if any required identifier is missing or inconsistent.

Registry. The domain identity registry associates the user domain identifier with identity, vault, minting, governance, index calibration, time-bank, exchange, and clearing permissions. The output of the registry stage is a route-permission object or denial state.

Route. The exchange or clearing routing engine receives token metadata and registry permissions, validates the signed index snapshot, and routes the asset to an exchange endpoint, time-bank endpoint, governance endpoint, wallet endpoint, or clearing endpoint. The output of the routing stage is a route status, clearing receipt hash, settlement batch identifier, or reconciliation hash.

### II. Module Inputs and Outputs

Behavioral Event Interface. Input: one or more upstream records required by the ordered pipeline. Output: a downstream object, hash, status, permission, snapshot, metadata object, receipt, or route state consumed by a later module. The module receives structured behavioral event objects and normalizes them into a canonical schema before any minting, indexing, or routing operation is allowed.

Behavioral Event Interface dependency. The module is configured so that a downstream minting, index, registry, exchange, or clearing operation cannot treat the module output as optional when the applicable policy bundle requires the module. This dependency transforms the system from a loose collection of token tools into a deterministic behavioral asset pipeline.

Behavioral Event Interface failure handling. The module may produce denial, quarantine, pending-review, downgraded output, manual-attestation request, revocation state, reversible freeze, or exception status. A failure code may be stored with a vault receipt or clearing receipt so that later audit can distinguish an unminted event from a rejected, pending, frozen, expired, delegated, or settled asset.

TransferKey SDK. Input: one or more upstream records required by the ordered pipeline. Output: a downstream object, hash, status, permission, snapshot, metadata object, receipt, or route state consumed by a later module. The module binds the behavioral event object to a user identity key and a user domain identifier and emits a cryptographic signature hash consumed by downstream modules.

TransferKey SDK dependency. The module is configured so that a downstream minting, index, registry, exchange, or clearing operation cannot treat the module output as optional when the applicable policy bundle requires the module. This dependency transforms the system from a loose collection of token tools into a deterministic behavioral asset pipeline.

TransferKey SDK failure handling. The module may produce denial, quarantine, pending-review, downgraded output, manual-attestation request, revocation state, reversible freeze, or exception status. A failure code may be stored with a vault receipt or clearing receipt so that later audit can distinguish an unminted event from a rejected, pending, frozen, expired, delegated, or settled asset.

Admission Gate State Machine. Input: one or more upstream records required by the ordered pipeline. Output: a downstream object, hash, status, permission, snapshot, metadata object, receipt, or route state consumed by a later module. The module validates nonce uniqueness, issuer authorization, consent scope, time-window eligibility, policy-version eligibility, registry permission, and quarantine status.

Admission Gate State Machine dependency. The module is configured so that a downstream minting, index, registry, exchange, or clearing operation cannot treat the module output as optional when the applicable policy bundle requires the module. This dependency transforms the system from a loose collection of token tools into a deterministic behavioral asset pipeline.

Admission Gate State Machine failure handling. The module may produce denial, quarantine, pending-review, downgraded output, manual-attestation request, revocation state, reversible freeze, or exception status. A failure code may be stored with a vault receipt or clearing receipt so that later audit can distinguish an unminted event from a rejected, pending, frozen, expired, delegated, or settled asset.

Encrypted Behavioral Vault. Input: one or more upstream records required by the ordered pipeline. Output: a downstream object, hash, status, permission, snapshot, metadata object, receipt, or route state consumed by a later module. The module stores encrypted payloads or evidence commitments and returns a vault identifier and receipt hash suitable for audit without exposing private behavior records.

Encrypted Behavioral Vault dependency. The module is configured so that a downstream minting, index, registry, exchange, or clearing operation cannot treat the module output as optional when the applicable policy bundle requires the module. This dependency transforms the system from a loose collection of token tools into a deterministic behavioral asset pipeline.

Encrypted Behavioral Vault failure handling. The module may produce denial, quarantine, pending-review, downgraded output, manual-attestation request, revocation state, reversible freeze, or exception status. A failure code may be stored with a vault receipt or clearing receipt so that later audit can distinguish an unminted event from a rejected, pending, frozen, expired, delegated, or settled asset.

BEI Index Snapshot Engine. Input: one or more upstream records required by the ordered pipeline. Output: a downstream object, hash, status, permission, snapshot, metadata object, receipt, or route state consumed by a later module. The module generates a signed index snapshot from the signature hash, vault identifier, behavior category, time window, policy version, and oracle or governance state.

BEI Index Snapshot Engine dependency. The module is configured so that a downstream minting, index, registry, exchange, or clearing operation cannot treat the module output as optional when the applicable policy bundle requires the module. This dependency transforms the system from a loose collection of token tools into a deterministic behavioral asset pipeline.

BEI Index Snapshot Engine failure handling. The module may produce denial, quarantine, pending-review, downgraded output, manual-attestation request, revocation state, reversible freeze, or exception status. A failure code may be stored with a vault receipt or clearing receipt so that later audit can distinguish an unminted event from a rejected, pending, frozen, expired, delegated, or settled asset.

Minting Engine. Input: one or more upstream records required by the ordered pipeline. Output: a downstream object, hash, status, permission, snapshot, metadata object, receipt, or route state consumed by a later module. The module creates token metadata only after the required upstream identifiers are verified as mutually consistent.

Minting Engine dependency. The module is configured so that a downstream minting, index, registry, exchange, or clearing operation cannot treat the module output as optional when the applicable policy bundle requires the module. This dependency transforms the system from a loose collection of token tools into a deterministic behavioral asset pipeline.

Minting Engine failure handling. The module may produce denial, quarantine, pending-review, downgraded output, manual-attestation request, revocation state, reversible freeze, or exception status. A failure code may be stored with a vault receipt or clearing receipt so that later audit can distinguish an unminted event from a rejected, pending, frozen, expired, delegated, or settled asset.

Domain Identity Registry. Input: one or more upstream records required by the ordered pipeline. Output: a downstream object, hash, status, permission, snapshot, metadata object, receipt, or route state consumed by a later module. The module maps domain names, subdomains, namespace basepoints, DID-style identifiers, or account-bound tokens to minting, vault, governance, index, exchange, and clearing permissions.

Domain Identity Registry dependency. The module is configured so that a downstream minting, index, registry, exchange, or clearing operation cannot treat the module output as optional when the applicable policy bundle requires the module. This dependency transforms the system from a loose collection of token tools into a deterministic behavioral asset pipeline.

Domain Identity Registry failure handling. The module may produce denial, quarantine, pending-review, downgraded output, manual-attestation request, revocation state, reversible freeze, or exception status. A failure code may be stored with a vault receipt or clearing receipt so that later audit can distinguish an unminted event from a rejected, pending, frozen, expired, delegated, or settled asset.

Exchange or Clearing Routing Engine. Input: one or more upstream records required by the ordered pipeline. Output: a downstream object, hash, status, permission, snapshot, metadata object, receipt, or route state consumed by a later module. The module routes token metadata to an exchange endpoint, time-bank endpoint, governance endpoint, wallet endpoint, clearing endpoint, or reconciliation endpoint.

Exchange or Clearing Routing Engine dependency. The module is configured so that a downstream minting, index, registry, exchange, or clearing operation cannot treat the module output as optional when the applicable policy bundle requires the module. This dependency transforms the system from a loose collection of token tools into a deterministic behavioral asset pipeline.

Exchange or Clearing Routing Engine failure handling. The module may produce denial, quarantine, pending-review, downgraded output, manual-attestation request, revocation state, reversible freeze, or exception status. A failure code may be stored with a vault receipt or clearing receipt so that later audit can distinguish an unminted event from a rejected, pending, frozen, expired, delegated, or settled asset.

### III. Data Objects and Schemas

BehaviorInput object. The BehaviorInput may include fields selected from eventId, userDomain, issuerId, timestamp, timeWindowId, behaviorCategory, contextVector, consentScope, evidenceCommitment, nonce, policyVersion, sourceDevice, sourceType, and optional biometricMetadata or emotionSeal. The object may be represented as JSON, XML, protocol buffer, database row, ledger record, Merkle leaf, verifiable credential payload, encrypted object, API response, smart contract event, or equivalent machine-readable structure.

BehaviorInput validation. A processor may validate the BehaviorInput by confirming field presence, formatting, policy version, time-window status, signature state, registry consistency, and hash linkage to at least one upstream or downstream object. Where plaintext is not required, the processor may validate commitments or selective proofs.

SignatureObject object. The SignatureObject may include fields selected from signatureHash, publicKeyId, domainBindingHash, timeWindowId, nonce, policyVersion, signerKeyClass, signatureAlgorithm, and verificationStatus. The object may be represented as JSON, XML, protocol buffer, database row, ledger record, Merkle leaf, verifiable credential payload, encrypted object, API response, smart contract event, or equivalent machine-readable structure.

SignatureObject validation. A processor may validate the SignatureObject by confirming field presence, formatting, policy version, time-window status, signature state, registry consistency, and hash linkage to at least one upstream or downstream object. Where plaintext is not required, the processor may validate commitments or selective proofs.

GateStateRecord object. The GateStateRecord may include fields selected from gateName, passFlag, failureCode, policyRule, reviewRequired, timestamp, issuerStatus, nonceStatus, consentStatus, registryStatus, and quarantineStatus. The object may be represented as JSON, XML, protocol buffer, database row, ledger record, Merkle leaf, verifiable credential payload, encrypted object, API response, smart contract event, or equivalent machine-readable structure.

GateStateRecord validation. A processor may validate the GateStateRecord by confirming field presence, formatting, policy version, time-window status, signature state, registry consistency, and hash linkage to at least one upstream or downstream object. Where plaintext is not required, the processor may validate commitments or selective proofs.

VaultReceipt object. The VaultReceipt may include fields selected from vaultId, receiptHash, payloadCommitment, accessPolicyHash, revocationState, retentionClass, encryptionClass, auditPointer, and reconciliationPointer. The object may be represented as JSON, XML, protocol buffer, database row, ledger record, Merkle leaf, verifiable credential payload, encrypted object, API response, smart contract event, or equivalent machine-readable structure.

VaultReceipt validation. A processor may validate the VaultReceipt by confirming field presence, formatting, policy version, time-window status, signature state, registry consistency, and hash linkage to at least one upstream or downstream object. Where plaintext is not required, the processor may validate commitments or selective proofs.

IndexSnapshot object. The IndexSnapshot may include fields selected from snapshotIndex, indexVersion, effectiveTime, timeWindowId, policyVersion, categoryWeight, sourceScore, tierFactor, anomalyFlag, oracleState, oracleSignature, and snapshotHash. The object may be represented as JSON, XML, protocol buffer, database row, ledger record, Merkle leaf, verifiable credential payload, encrypted object, API response, smart contract event, or equivalent machine-readable structure.

IndexSnapshot validation. A processor may validate the IndexSnapshot by confirming field presence, formatting, policy version, time-window status, signature state, registry consistency, and hash linkage to at least one upstream or downstream object. Where plaintext is not required, the processor may validate commitments or selective proofs.

MintMetadata object. The MintMetadata may include fields selected from tokenId, assetType, userDomain, vaultId, signatureHash, snapshotIndex, policyVersion, consentScope, mintTxHash, clearingReceiptHash, transferMode, and routeClass. The object may be represented as JSON, XML, protocol buffer, database row, ledger record, Merkle leaf, verifiable credential payload, encrypted object, API response, smart contract event, or equivalent machine-readable structure.

MintMetadata validation. A processor may validate the MintMetadata by confirming field presence, formatting, policy version, time-window status, signature state, registry consistency, and hash linkage to at least one upstream or downstream object. Where plaintext is not required, the processor may validate commitments or selective proofs.

DomainRegistryRecord object. The DomainRegistryRecord may include fields selected from userDomain, identityAnchor, vaultRoute, mintRoute, exchangeRoute, clearingRoute, timeBankRoute, governanceRoute, indexCalibrationRights, registryVersion, endpointSignature, and effectiveTimeWindow. The object may be represented as JSON, XML, protocol buffer, database row, ledger record, Merkle leaf, verifiable credential payload, encrypted object, API response, smart contract event, or equivalent machine-readable structure.

DomainRegistryRecord validation. A processor may validate the DomainRegistryRecord by confirming field presence, formatting, policy version, time-window status, signature state, registry consistency, and hash linkage to at least one upstream or downstream object. Where plaintext is not required, the processor may validate commitments or selective proofs.

ClearingReceipt object. The ClearingReceipt may include fields selected from clearingReceiptHash, settlementBatchId, nettingWindow, counterpartyRoute, clearingEndpointId, routeStatus, reconciliationHash, mintTxHash, vaultId, snapshotIndex, and exceptionStatus. The object may be represented as JSON, XML, protocol buffer, database row, ledger record, Merkle leaf, verifiable credential payload, encrypted object, API response, smart contract event, or equivalent machine-readable structure.

ClearingReceipt validation. A processor may validate the ClearingReceipt by confirming field presence, formatting, policy version, time-window status, signature state, registry consistency, and hash linkage to at least one upstream or downstream object. Where plaintext is not required, the processor may validate commitments or selective proofs.

PolicyBundle object. The PolicyBundle may include fields selected from policyId, version, authorizedSourceRules, categoryRules, consentRules, timeWindowRules, rateLimits, mintCaps, indexCoefficients, listingRules, clearingRules, revocationRules, emergencyRules, and effectiveTimeWindow. The object may be represented as JSON, XML, protocol buffer, database row, ledger record, Merkle leaf, verifiable credential payload, encrypted object, API response, smart contract event, or equivalent machine-readable structure.

PolicyBundle validation. A processor may validate the PolicyBundle by confirming field presence, formatting, policy version, time-window status, signature state, registry consistency, and hash linkage to at least one upstream or downstream object. Where plaintext is not required, the processor may validate commitments or selective proofs.

### IV. Admission Gate State Machine

START. In a non-limiting gate implementation, the state machine enters the START state to test, record, or output a specific validation condition. The state can consume a behavioral event object, signature object, policy bundle, domain registry record, vault receipt, or index snapshot, and can output a pass flag, failure code, review flag, or quarantine status.

FIELD_CHECK. In a non-limiting gate implementation, the state machine enters the FIELD_CHECK state to test, record, or output a specific validation condition. The state can consume a behavioral event object, signature object, policy bundle, domain registry record, vault receipt, or index snapshot, and can output a pass flag, failure code, review flag, or quarantine status.

NONCE_CHECK. In a non-limiting gate implementation, the state machine enters the NONCE_CHECK state to test, record, or output a specific validation condition. The state can consume a behavioral event object, signature object, policy bundle, domain registry record, vault receipt, or index snapshot, and can output a pass flag, failure code, review flag, or quarantine status.

TIME_WINDOW_CHECK. In a non-limiting gate implementation, the state machine enters the TIME_WINDOW_CHECK state to test, record, or output a specific validation condition. The state can consume a behavioral event object, signature object, policy bundle, domain registry record, vault receipt, or index snapshot, and can output a pass flag, failure code, review flag, or quarantine status.

CONSENT_CHECK. In a non-limiting gate implementation, the state machine enters the CONSENT_CHECK state to test, record, or output a specific validation condition. The state can consume a behavioral event object, signature object, policy bundle, domain registry record, vault receipt, or index snapshot, and can output a pass flag, failure code, review flag, or quarantine status.

ISSUER_CHECK. In a non-limiting gate implementation, the state machine enters the ISSUER_CHECK state to test, record, or output a specific validation condition. The state can consume a behavioral event object, signature object, policy bundle, domain registry record, vault receipt, or index snapshot, and can output a pass flag, failure code, review flag, or quarantine status.

POLICY_CHECK. In a non-limiting gate implementation, the state machine enters the POLICY_CHECK state to test, record, or output a specific validation condition. The state can consume a behavioral event object, signature object, policy bundle, domain registry record, vault receipt, or index snapshot, and can output a pass flag, failure code, review flag, or quarantine status.

REGISTRY_CHECK. In a non-limiting gate implementation, the state machine enters the REGISTRY_CHECK state to test, record, or output a specific validation condition. The state can consume a behavioral event object, signature object, policy bundle, domain registry record, vault receipt, or index snapshot, and can output a pass flag, failure code, review flag, or quarantine status.

VAULT_CHECK. In a non-limiting gate implementation, the state machine enters the VAULT_CHECK state to test, record, or output a specific validation condition. The state can consume a behavioral event object, signature object, policy bundle, domain registry record, vault receipt, or index snapshot, and can output a pass flag, failure code, review flag, or quarantine status.

SNAPSHOT_CHECK. In a non-limiting gate implementation, the state machine enters the SNAPSHOT_CHECK state to test, record, or output a specific validation condition. The state can consume a behavioral event object, signature object, policy bundle, domain registry record, vault receipt, or index snapshot, and can output a pass flag, failure code, review flag, or quarantine status.

MINT_ELIGIBLE. In a non-limiting gate implementation, the state machine enters the MINT_ELIGIBLE state to test, record, or output a specific validation condition. The state can consume a behavioral event object, signature object, policy bundle, domain registry record, vault receipt, or index snapshot, and can output a pass flag, failure code, review flag, or quarantine status.

FAILURE_CODE. In a non-limiting gate implementation, the state machine enters the FAILURE_CODE state to test, record, or output a specific validation condition. The state can consume a behavioral event object, signature object, policy bundle, domain registry record, vault receipt, or index snapshot, and can output a pass flag, failure code, review flag, or quarantine status.

QUARANTINE. In a non-limiting gate implementation, the state machine enters the QUARANTINE state to test, record, or output a specific validation condition. The state can consume a behavioral event object, signature object, policy bundle, domain registry record, vault receipt, or index snapshot, and can output a pass flag, failure code, review flag, or quarantine status.

The Admission Gate may deny minting when a stale time window, duplicated nonce, missing consent scope, unauthorized issuer, invalid signature, inconsistent policy version, missing registry permission, consumed signature hash, revoked domain route, or corrupted vault receipt is detected.

The Admission Gate may permit vaulting without minting, indexing without transferability, or audit-only preservation when a policy bundle permits partial processing. In such cases, token metadata cannot be completed as a transferable asset until the failed condition is resolved or a policy-authorized override is recorded.

### V. Transferkey SDK Implementation

signBehavior. The TransferKey SDK may expose a function named signBehavior or an equivalent interface that receives a behavioral event object and user identity key and returns a signature hash bound to the nonce, time window, policy version, and user domain identifier.

requestVaultCommitment. The TransferKey SDK may expose a function named requestVaultCommitment or an equivalent interface that submits or references an encrypted payload or evidence commitment and obtains a vault identifier and receipt hash.

requestIndexSnapshot. The TransferKey SDK may expose a function named requestIndexSnapshot or an equivalent interface that requests a BEI index snapshot using the signature hash, vault identifier, behavior category, policy version, and time window.

mintBehavioralAsset. The TransferKey SDK may expose a function named mintBehavioralAsset or an equivalent interface that requests token metadata creation after gate, vault, and snapshot outputs are verified.

validateVault. The TransferKey SDK may expose a function named validateVault or an equivalent interface that checks whether a vault identifier, receipt hash, payload commitment, and access policy are consistent.

validateClearingRoute. The TransferKey SDK may expose a function named validateClearingRoute or an equivalent interface that checks whether the user domain identifier and token metadata are eligible for exchange, time-bank, governance, wallet, or clearing routing.

The SDK may operate on a client device, mobile phone, web browser, wallet application, hardware security module, IoT controller, cloud service, API gateway, smart contract runtime, permissioned ledger node, or hybrid implementation. The SDK may store private keys locally, delegate signing to a hardware module, or use threshold signatures according to policy.

The SDK may prevent re-use of a nonce by consulting a local state cache, a ledger state, a vault state, a registry state, or an Admission Gate state. This provides a technical safeguard against double-minting and stale event submission.

### VI. Encrypted Behavioral Vault and Privacy-Preserving Audit

The encrypted behavioral vault may store raw behavior payloads, encrypted payloads, field-level encrypted payloads, hash-only commitments, Merkle roots, verifiable credential references, off-chain data pointers, or selective disclosure objects. The vault can preserve privacy while producing a receipt hash that is usable by downstream index, mint, exchange, and clearing modules.

A vault receipt may be anchored to a tamper-evident structure including a distributed ledger, permissioned ledger, append-only log, Merkle tree, write-once storage structure, timestamp service, or equivalent integrity-preserving structure. No particular public blockchain is required.

The vault may implement viewing rights, signing rights, transfer rights, governance rights, settlement rights, inheritance rights, emergency access rights, and revocation rights as separate policy-controlled permissions. This separation allows a family member, institution, auditor, regulator, exchange, or clearing node to receive only the access needed for a defined operation.

The vault may update a reconciliation hash after a mint transaction, listing event, time-bank deposit, exchange match, clearing batch, settlement instruction, exception event, or final receipt. The raw behavior payload may remain encrypted while the reconciliation hash proves continuity between the underlying event and the later asset state.

### VII. BEI Index Snapshot Engine

The BEI index snapshot engine computes a snapshot from defined inputs rather than from an unconstrained subjective valuation. Non-limiting inputs include behavior category weight, source confidence, user tier state, time-window weight, anomaly score, oracle state, governance coefficient, mint cap, consent scope, and policy version.

The signed snapshot can include an index version, effective time, time-window identifier, policy-version identifier, category weight, source score, anomaly flag, oracle signature, and snapshot hash. The snapshot is frozen for the minted asset even if a later exchange quote, oracle feed, policy coefficient, or governance rule changes.

The snapshot can be used for pricing, listing eligibility, time-bank routing, service-unit redemption, governance weighting, vault audit, clearing eligibility, or reconciliation. The snapshot is distinguishable from private raw behavior data and can therefore be transmitted to endpoints that do not receive the underlying payload.

A sovereign oracle or behavior-value ratio engine may aggregate behavior-value ratios across users, categories, regions, time windows, and policies while preserving privacy through commitments, differential aggregation, selective disclosure, or other privacy-preserving mechanisms. The oracle may emit signed feeds consumed by the index snapshot engine or exchange routing engine.

A non-limiting IndexScore may be computed as baseWeight multiplied by sourceScore, tierFactor, timeWindowFactor, and anomalyAdjustment. A non-limiting BehaviorValueRatio may be computed as verifiedBehaviorUnits divided by eligibleMintCapacity. A non-limiting MintEligibility expression may be AdmissionGatePassed and VaultCommitted and SnapshotSigned and DomainPermissionValid. The specific formulas may be replaced by equivalent rule-based, table-driven, statistical, machine-learning-assisted, or oracle-assisted computations under a signed policy bundle.

### VIII. Minting Engine and Metadata Binding

The minting engine generates token metadata only after receiving verified upstream outputs. In preferred embodiments, token metadata is incomplete unless at least a user domain identifier, signature hash, vault identifier, signed index snapshot, policy version, consent scope, and mint transaction hash are present or derivable from tamper-evident records.

The minting engine may mint an NFT, ERC1155-style asset, permissioned ledger unit, time-denominated credit, service unit, account-bound unit, non-transferable unit, claim object, or settlement-recognized digital asset. The invention does not require legal-tender status or a particular blockchain standard.

Token metadata may include a transfer mode selected from internal-only, non-transferable, transferable, listed, restricted, blocked, frozen, expired, inherited, delegated, or audit-only. The transfer mode may be assigned by the Admission Gate, policy bundle, registry, exchange router, or clearing router.

Metadata orphaning resistance is provided by blocking completion of the mint transaction when upstream identifiers are missing or inconsistent. The minting engine may call vault validation, index snapshot verification, domain registry resolution, and clearing route validation before recording a mint transaction hash.

The minted asset may remain usable for audit, service redemption, time-bank deposit, governance, or internal settlement even if public exchange transferability is not permitted. This allows the system to support regulated or sensitive behavior categories while preserving the core evidentiary relationship.

### IX. Domain Identity Registry and Signed Endpoint Routing

The domain identity registry maps a user domain identifier to a plurality of endpoint roles. Non-limiting roles include proof endpoint, policy endpoint, mint endpoint, index endpoint, exchange endpoint, time-bank endpoint, clearing endpoint, wallet endpoint, governance endpoint, audit endpoint, and revocation endpoint.

A domain or subdomain is not merely a website address in the disclosed system. It can operate as a namespace basepoint that publishes signed endpoint records and registry permissions used by the behavioral asset pipeline. A domain record may be bound to a decentralized identifier, verifiable credential, account-bound token, non-transferable identity token, public key, certificate, wallet, or hardware key.

Each endpoint record may include role, endpoint URI, public key, key version, policy version, validity window, route class, revocation status, signature, and optional DNSSEC, DANE, certificate, or DID-document binding. The system may deny minting, listing, or clearing if the endpoint record is stale, revoked, unsigned, or inconsistent with a policy bundle.

Domain-based routing allows BEI assets to be generated at an identity layer while remaining routable to exchange, time-bank, governance, and clearing nodes. A domain node may represent a person, household, family, institution, sector, country, region, time window, behavior category, or service route, provided the registry preserves the required endpoint and permission relationships.

Non-limiting domain basepoints may include identity, time, minting, index, wallet, exchange, and clearing entry nodes. Specific domain strings are implementation examples and are not required for practicing the invention.

### X. Exchange, Time-Bank, Governance, and Clearing Routing

Listing Intake. The exchange or clearing routing engine may perform listing intake that receives token metadata and validates signatureHash, vaultId, userDomain, snapshotIndex, policyVersion, and mintTxHash before a listing, quotation, or route request is accepted. The step may output a status code, timestamp, route identifier, batch identifier, participant identifier, asset identifier, settlement instruction, exception code, or hash commitment.

Eligibility Check. The exchange or clearing routing engine may perform eligibility check that determines whether the asset is internal-only, non-transferable, transferable, listed, restricted, blocked, time-bank-only, governance-only, audit-only, or clearing-eligible. The step may output a status code, timestamp, route identifier, batch identifier, participant identifier, asset identifier, settlement instruction, exception code, or hash commitment.

Order Matching. The exchange or clearing routing engine may perform order matching that matches listed behavioral assets against bids, service requests, redemption requests, time-bank offsets, governance allocations, or clearing obligations. The step may output a status code, timestamp, route identifier, batch identifier, participant identifier, asset identifier, settlement instruction, exception code, or hash commitment.

Netting. The exchange or clearing routing engine may perform netting that nets obligations by user domain, asset class, time window, counterparty route, clearing member, policy version, or settlement batch. The step may output a status code, timestamp, route identifier, batch identifier, participant identifier, asset identifier, settlement instruction, exception code, or hash commitment.

Settlement Instruction. The exchange or clearing routing engine may perform settlement instruction that generates instructions identifying asset movement, service redemption, account credit, settlement route, or reconciliation state. The step may output a status code, timestamp, route identifier, batch identifier, participant identifier, asset identifier, settlement instruction, exception code, or hash commitment.

Reconciliation. The exchange or clearing routing engine may perform reconciliation that cross-checks vault receipts, mint transaction hashes, snapshot identifiers, registry routes, and settlement status to generate a reconciliation hash. The step may output a status code, timestamp, route identifier, batch identifier, participant identifier, asset identifier, settlement instruction, exception code, or hash commitment.

Exception Handling. The exchange or clearing routing engine may perform exception handling that routes missing receipts, invalid policy versions, disputed events, revoked domains, incomplete metadata, or stale endpoints to quarantine, review, freeze, correction, expiration, or rollback-ready status. The step may output a status code, timestamp, route identifier, batch identifier, participant identifier, asset identifier, settlement instruction, exception code, or hash commitment.

Final Receipt. The exchange or clearing routing engine may perform final receipt that creates a final clearing receipt hash linked to the mint transaction hash, settlement batch, netting window, and reconciliation hash. The step may output a status code, timestamp, route identifier, batch identifier, participant identifier, asset identifier, settlement instruction, exception code, or hash commitment.

### XI. Security and Anti-Fraud Controls

Replay Attack Resistance. The system may reject or quarantine duplicate event identifiers, stale nonces, repeated signature hashes, consumed time-window proofs, and duplicate evidence commitments. This control changes how processors validate, store, index, mint, route, and reconcile behavioral event data, and distinguishes the pipeline from ordinary reward points, unverified NFTs, or generic token marketplaces.

Source Spoofing Resistance. The system may check issuer keys against authorized-source rules in the signed policy bundle and registry endpoint records. This control changes how processors validate, store, index, mint, route, and reconcile behavioral event data, and distinguishes the pipeline from ordinary reward points, unverified NFTs, or generic token marketplaces.

Vault Tamper Resistance. The system may bind encrypted payloads to receipt hashes, payload commitments, access policy hashes, and optional tamper-evident anchors. This control changes how processors validate, store, index, mint, route, and reconcile behavioral event data, and distinguishes the pipeline from ordinary reward points, unverified NFTs, or generic token marketplaces.

Index Manipulation Resistance. The system may generate index snapshots that include index version, policy version, oracle signature, effective time, and snapshot hash. This control changes how processors validate, store, index, mint, route, and reconcile behavioral event data, and distinguishes the pipeline from ordinary reward points, unverified NFTs, or generic token marketplaces.

Metadata Orphaning Resistance. The system may require token metadata to include upstream vault and signature identifiers before the mint transaction is complete. This control changes how processors validate, store, index, mint, route, and reconcile behavioral event data, and distinguishes the pipeline from ordinary reward points, unverified NFTs, or generic token marketplaces.

Domain Hijack Resistance. The system may require domain records to use signed endpoint records, certificate bindings, DNSSEC, DANE, multi-factor control proofs, or equivalent domain-control verification. This control changes how processors validate, store, index, mint, route, and reconcile behavioral event data, and distinguishes the pipeline from ordinary reward points, unverified NFTs, or generic token marketplaces.

Clearing Fraud Resistance. The system may reconcile settlement batches against mint transaction hashes, vault identifiers, snapshot indexes, route statuses, and clearing receipt hashes. This control changes how processors validate, store, index, mint, route, and reconcile behavioral event data, and distinguishes the pipeline from ordinary reward points, unverified NFTs, or generic token marketplaces.

Privacy Leakage Resistance. The system may keep raw behavior records encrypted while commitments, signatures, index snapshots, and receipts provide auditability. This control changes how processors validate, store, index, mint, route, and reconcile behavioral event data, and distinguishes the pipeline from ordinary reward points, unverified NFTs, or generic token marketplaces.

Policy Drift Resistance. The system may retain historical policy versions for previously minted assets while evaluating new behavior events under an effective policy version according to predetermined conflict-resolution rules. This control changes how processors validate, store, index, mint, route, and reconcile behavioral event data, and distinguishes the pipeline from ordinary reward points, unverified NFTs, or generic token marketplaces.

Emergency Quarantine. The system may trigger alert or quarantine routing when an anomaly spike is detected, without automatically minting a transferable asset. This control changes how processors validate, store, index, mint, route, and reconcile behavioral event data, and distinguishes the pipeline from ordinary reward points, unverified NFTs, or generic token marketplaces.

### XII. Policy Bundle Enforcement

A signed policy bundle may include authorized source rules, signed by an authorized governance key and associated with a version and effective time window. When authorized source rules change, the system may retain historical versions for previously minted assets and apply new versions to subsequent events according to conflict-resolution rules stored in the policy bundle.

A signed policy bundle may include activity taxonomy rules, signed by an authorized governance key and associated with a version and effective time window. When activity taxonomy rules change, the system may retain historical versions for previously minted assets and apply new versions to subsequent events according to conflict-resolution rules stored in the policy bundle.

A signed policy bundle may include consent rules, signed by an authorized governance key and associated with a version and effective time window. When consent rules change, the system may retain historical versions for previously minted assets and apply new versions to subsequent events according to conflict-resolution rules stored in the policy bundle.

A signed policy bundle may include time-window rules, signed by an authorized governance key and associated with a version and effective time window. When time-window rules change, the system may retain historical versions for previously minted assets and apply new versions to subsequent events according to conflict-resolution rules stored in the policy bundle.

A signed policy bundle may include rate limit rules, signed by an authorized governance key and associated with a version and effective time window. When rate limit rules change, the system may retain historical versions for previously minted assets and apply new versions to subsequent events according to conflict-resolution rules stored in the policy bundle.

A signed policy bundle may include mint cap rules, signed by an authorized governance key and associated with a version and effective time window. When mint cap rules change, the system may retain historical versions for previously minted assets and apply new versions to subsequent events according to conflict-resolution rules stored in the policy bundle.

A signed policy bundle may include index rules, signed by an authorized governance key and associated with a version and effective time window. When index rules change, the system may retain historical versions for previously minted assets and apply new versions to subsequent events according to conflict-resolution rules stored in the policy bundle.

A signed policy bundle may include domain permission rules, signed by an authorized governance key and associated with a version and effective time window. When domain permission rules change, the system may retain historical versions for previously minted assets and apply new versions to subsequent events according to conflict-resolution rules stored in the policy bundle.

A signed policy bundle may include listing rules, signed by an authorized governance key and associated with a version and effective time window. When listing rules change, the system may retain historical versions for previously minted assets and apply new versions to subsequent events according to conflict-resolution rules stored in the policy bundle.

A signed policy bundle may include clearing rules, signed by an authorized governance key and associated with a version and effective time window. When clearing rules change, the system may retain historical versions for previously minted assets and apply new versions to subsequent events according to conflict-resolution rules stored in the policy bundle.

A signed policy bundle may include revocation rules, signed by an authorized governance key and associated with a version and effective time window. When revocation rules change, the system may retain historical versions for previously minted assets and apply new versions to subsequent events according to conflict-resolution rules stored in the policy bundle.

A signed policy bundle may include emergency exception rules, signed by an authorized governance key and associated with a version and effective time window. When emergency exception rules change, the system may retain historical versions for previously minted assets and apply new versions to subsequent events according to conflict-resolution rules stored in the policy bundle.

A signed policy bundle may include inheritance delegation rules, signed by an authorized governance key and associated with a version and effective time window. When inheritance delegation rules change, the system may retain historical versions for previously minted assets and apply new versions to subsequent events according to conflict-resolution rules stored in the policy bundle.

A signed policy bundle may include privacy disclosure rules, signed by an authorized governance key and associated with a version and effective time window. When privacy disclosure rules change, the system may retain historical versions for previously minted assets and apply new versions to subsequent events according to conflict-resolution rules stored in the policy bundle.

### XIII. Field-of-Use Embodiments

Caregiving and Household Time. In one embodiment, a family, care institution, or household terminal records a caregiving event; the SDK signs the event, the vault preserves an evidence commitment, the index engine computes a caregiving time snapshot, and a time-bank node receives a clearing receipt. The implementation may restrict transferability, anonymize raw behavior data, expose only commitments, and maintain a signed snapshotIndex for audit and valuation.

Caregiving and Household Time licensing relevance. The same underlying technical pipeline can support SDK licensing, vault hosting, index oracle access, domain registry services, minting fees, exchange routing, time-bank routing, clearing receipt generation, certification services, and field-specific white-label deployments.

Education and Skill Progress. In one embodiment, a school, certification body, or learning application attests to a skill achievement; behavior category weight and issuer authorization are evaluated before an education behavior asset can be minted or routed. The implementation may restrict transferability, anonymize raw behavior data, expose only commitments, and maintain a signed snapshotIndex for audit and valuation.

Education and Skill Progress licensing relevance. The same underlying technical pipeline can support SDK licensing, vault hosting, index oracle access, domain registry services, minting fees, exchange routing, time-bank routing, clearing receipt generation, certification services, and field-specific white-label deployments.

Preventive Health and Wellness. In one embodiment, a health application or clinic captures a consented preventive-care event; private health data remain encrypted or off-chain while a non-diagnostic behavior asset is routed for incentive or service-unit settlement. The implementation may restrict transferability, anonymize raw behavior data, expose only commitments, and maintain a signed snapshotIndex for audit and valuation.

Preventive Health and Wellness licensing relevance. The same underlying technical pipeline can support SDK licensing, vault hosting, index oracle access, domain registry services, minting fees, exchange routing, time-bank routing, clearing receipt generation, certification services, and field-specific white-label deployments.

Work and Professional Contribution. In one embodiment, a workplace, guild, professional body, or institutional source signs a contribution record; category-specific index parameters determine whether the asset is eligible for marketplace listing, internal settlement, or governance use. The implementation may restrict transferability, anonymize raw behavior data, expose only commitments, and maintain a signed snapshotIndex for audit and valuation.

Work and Professional Contribution licensing relevance. The same underlying technical pipeline can support SDK licensing, vault hosting, index oracle access, domain registry services, minting fees, exchange routing, time-bank routing, clearing receipt generation, certification services, and field-specific white-label deployments.

Green and Community Contribution. In one embodiment, a verified environmental or civic contribution is signed and indexed; the resulting asset may be routed to an impact index, community treasury, exchange list, or clearing node under policy-specific caps. The implementation may restrict transferability, anonymize raw behavior data, expose only commitments, and maintain a signed snapshotIndex for audit and valuation.

Green and Community Contribution licensing relevance. The same underlying technical pipeline can support SDK licensing, vault hosting, index oracle access, domain registry services, minting fees, exchange routing, time-bank routing, clearing receipt generation, certification services, and field-specific white-label deployments.

Disaster Volunteer Response. In one embodiment, a verified emergency response event is vaulted quickly, marked high priority, and routed to a restricted clearing route for later reconciliation without necessarily creating a public tradable asset. The implementation may restrict transferability, anonymize raw behavior data, expose only commitments, and maintain a signed snapshotIndex for audit and valuation.

Disaster Volunteer Response licensing relevance. The same underlying technical pipeline can support SDK licensing, vault hosting, index oracle access, domain registry services, minting fees, exchange routing, time-bank routing, clearing receipt generation, certification services, and field-specific white-label deployments.

Family Inheritance Vault. In one embodiment, a user assigns viewing or settlement rights to heirs while preserving private behavior data and separating signing authority from transfer, governance, and settlement authority. The implementation may restrict transferability, anonymize raw behavior data, expose only commitments, and maintain a signed snapshotIndex for audit and valuation.

Family Inheritance Vault licensing relevance. The same underlying technical pipeline can support SDK licensing, vault hosting, index oracle access, domain registry services, minting fees, exchange routing, time-bank routing, clearing receipt generation, certification services, and field-specific white-label deployments.

DAO Calibration Vote. In one embodiment, a domain-controlled governance member votes on an index policy update; the vote may be stored as a behavioral event with governance metadata and a signed snapshot. The implementation may restrict transferability, anonymize raw behavior data, expose only commitments, and maintain a signed snapshotIndex for audit and valuation.

DAO Calibration Vote licensing relevance. The same underlying technical pipeline can support SDK licensing, vault hosting, index oracle access, domain registry services, minting fees, exchange routing, time-bank routing, clearing receipt generation, certification services, and field-specific white-label deployments.

Employer Skill Bonus. In one embodiment, an employer attests to a completed work unit; the asset becomes eligible for internal bonus settlement, time-bank offset, or clearing reconciliation rather than public exchange listing. The implementation may restrict transferability, anonymize raw behavior data, expose only commitments, and maintain a signed snapshotIndex for audit and valuation.

Employer Skill Bonus licensing relevance. The same underlying technical pipeline can support SDK licensing, vault hosting, index oracle access, domain registry services, minting fees, exchange routing, time-bank routing, clearing receipt generation, certification services, and field-specific white-label deployments.

Cross-Border Service Exchange. In one embodiment, an asset minted under one policy profile is routed to another jurisdiction only if the registry and policy bundle both authorize the route and a clearing receipt records the cross-route reconciliation. The implementation may restrict transferability, anonymize raw behavior data, expose only commitments, and maintain a signed snapshotIndex for audit and valuation.

Cross-Border Service Exchange licensing relevance. The same underlying technical pipeline can support SDK licensing, vault hosting, index oracle access, domain registry services, minting fees, exchange routing, time-bank routing, clearing receipt generation, certification services, and field-specific white-label deployments.

### XIV. Implementation Profiles

Single-Enterprise Deployment. In this deployment profile, one enterprise operates the SDK gateway, vault, index engine, minting engine, registry resolver, and clearing router for internal behavioral assets. The same claim architecture applies because the behavioral event object, signature hash, vault identifier, index snapshot, domain identity record, mint transaction hash, and clearing receipt remain linked.

Consortium Deployment. In this deployment profile, multiple institutions share authorized source rules and clearing routes while maintaining separate vaults or separate domain registry partitions. The same claim architecture applies because the behavioral event object, signature hash, vault identifier, index snapshot, domain identity record, mint transaction hash, and clearing receipt remain linked.

Public Network Deployment. In this deployment profile, users control domain identities and wallets while index and clearing endpoints publish signed policy bundles and endpoint records. The same claim architecture applies because the behavioral event object, signature hash, vault identifier, index snapshot, domain identity record, mint transaction hash, and clearing receipt remain linked.

Regulated Sandbox Deployment. In this deployment profile, a limited behavior category and limited transfer scope are used to validate the pipeline before broader operation. The same claim architecture applies because the behavioral event object, signature hash, vault identifier, index snapshot, domain identity record, mint transaction hash, and clearing receipt remain linked.

White-Label Deployment. In this deployment profile, a partner receives a branded interface while the underlying TransferKey, vault, index, domain registry, minting, and clearing identifiers remain interoperable. The same claim architecture applies because the behavioral event object, signature hash, vault identifier, index snapshot, domain identity record, mint transaction hash, and clearing receipt remain linked.

### XV. Hardware and Software Environment

The system may operate on or communicate with a mobile phone processor. The mobile phone processor may execute a portion of the TransferKey SDK, Admission Gate, encrypted vault, BEI index snapshot engine, minting engine, registry resolver, exchange router, clearing router, or policy bundle validator depending on deployment requirements.

The system may operate on or communicate with a web server. The web server may execute a portion of the TransferKey SDK, Admission Gate, encrypted vault, BEI index snapshot engine, minting engine, registry resolver, exchange router, clearing router, or policy bundle validator depending on deployment requirements.

The system may operate on or communicate with a cloud function. The cloud function may execute a portion of the TransferKey SDK, Admission Gate, encrypted vault, BEI index snapshot engine, minting engine, registry resolver, exchange router, clearing router, or policy bundle validator depending on deployment requirements.

The system may operate on or communicate with an edge device. The edge device may execute a portion of the TransferKey SDK, Admission Gate, encrypted vault, BEI index snapshot engine, minting engine, registry resolver, exchange router, clearing router, or policy bundle validator depending on deployment requirements.

The system may operate on or communicate with an embedded IoT controller. The embedded IoT controller may execute a portion of the TransferKey SDK, Admission Gate, encrypted vault, BEI index snapshot engine, minting engine, registry resolver, exchange router, clearing router, or policy bundle validator depending on deployment requirements.

The system may operate on or communicate with a hardware security module. The hardware security module may execute a portion of the TransferKey SDK, Admission Gate, encrypted vault, BEI index snapshot engine, minting engine, registry resolver, exchange router, clearing router, or policy bundle validator depending on deployment requirements.

The system may operate on or communicate with a wallet application. The wallet application may execute a portion of the TransferKey SDK, Admission Gate, encrypted vault, BEI index snapshot engine, minting engine, registry resolver, exchange router, clearing router, or policy bundle validator depending on deployment requirements.

The system may operate on or communicate with a database cluster. The database cluster may execute a portion of the TransferKey SDK, Admission Gate, encrypted vault, BEI index snapshot engine, minting engine, registry resolver, exchange router, clearing router, or policy bundle validator depending on deployment requirements.

The system may operate on or communicate with a permissioned ledger node. The permissioned ledger node may execute a portion of the TransferKey SDK, Admission Gate, encrypted vault, BEI index snapshot engine, minting engine, registry resolver, exchange router, clearing router, or policy bundle validator depending on deployment requirements.

The system may operate on or communicate with a smart contract runtime. The smart contract runtime may execute a portion of the TransferKey SDK, Admission Gate, encrypted vault, BEI index snapshot engine, minting engine, registry resolver, exchange router, clearing router, or policy bundle validator depending on deployment requirements.

The system may operate on or communicate with a message queue. The message queue may execute a portion of the TransferKey SDK, Admission Gate, encrypted vault, BEI index snapshot engine, minting engine, registry resolver, exchange router, clearing router, or policy bundle validator depending on deployment requirements.

The system may operate on or communicate with an API gateway. The API gateway may execute a portion of the TransferKey SDK, Admission Gate, encrypted vault, BEI index snapshot engine, minting engine, registry resolver, exchange router, clearing router, or policy bundle validator depending on deployment requirements.

The system may operate on or communicate with a time-bank terminal. The time-bank terminal may execute a portion of the TransferKey SDK, Admission Gate, encrypted vault, BEI index snapshot engine, minting engine, registry resolver, exchange router, clearing router, or policy bundle validator depending on deployment requirements.

The system may operate on or communicate with an exchange matching server. The exchange matching server may execute a portion of the TransferKey SDK, Admission Gate, encrypted vault, BEI index snapshot engine, minting engine, registry resolver, exchange router, clearing router, or policy bundle validator depending on deployment requirements.

The system may operate on or communicate with a clearinghouse server. The clearinghouse server may execute a portion of the TransferKey SDK, Admission Gate, encrypted vault, BEI index snapshot engine, minting engine, registry resolver, exchange router, clearing router, or policy bundle validator depending on deployment requirements.

The system may operate on or communicate with a governance dashboard. The governance dashboard may execute a portion of the TransferKey SDK, Admission Gate, encrypted vault, BEI index snapshot engine, minting engine, registry resolver, exchange router, clearing router, or policy bundle validator depending on deployment requirements.

### XVI. Examiner-Focused Technical Character

The disclosure includes ordered module dependency. This feature contributes to the technical character of the invention because it changes how processors validate, store, index, mint, route, and reconcile behavioral event data rather than merely describing a desired financial or social outcome.

The disclosure includes specific data structures. This feature contributes to the technical character of the invention because it changes how processors validate, store, index, mint, route, and reconcile behavioral event data rather than merely describing a desired financial or social outcome.

The disclosure includes cryptographic signature hashes. This feature contributes to the technical character of the invention because it changes how processors validate, store, index, mint, route, and reconcile behavioral event data rather than merely describing a desired financial or social outcome.

The disclosure includes nonce and replay-prevention checks. This feature contributes to the technical character of the invention because it changes how processors validate, store, index, mint, route, and reconcile behavioral event data rather than merely describing a desired financial or social outcome.

The disclosure includes encrypted vault identifiers. This feature contributes to the technical character of the invention because it changes how processors validate, store, index, mint, route, and reconcile behavioral event data rather than merely describing a desired financial or social outcome.

The disclosure includes signed BEI index snapshots. This feature contributes to the technical character of the invention because it changes how processors validate, store, index, mint, route, and reconcile behavioral event data rather than merely describing a desired financial or social outcome.

The disclosure includes domain registry permissions. This feature contributes to the technical character of the invention because it changes how processors validate, store, index, mint, route, and reconcile behavioral event data rather than merely describing a desired financial or social outcome.

The disclosure includes token metadata binding. This feature contributes to the technical character of the invention because it changes how processors validate, store, index, mint, route, and reconcile behavioral event data rather than merely describing a desired financial or social outcome.

The disclosure includes clearing receipt hashes. This feature contributes to the technical character of the invention because it changes how processors validate, store, index, mint, route, and reconcile behavioral event data rather than merely describing a desired financial or social outcome.

The disclosure includes failure codes and quarantine states. This feature contributes to the technical character of the invention because it changes how processors validate, store, index, mint, route, and reconcile behavioral event data rather than merely describing a desired financial or social outcome.

The disclosure includes policy bundle versioning. This feature contributes to the technical character of the invention because it changes how processors validate, store, index, mint, route, and reconcile behavioral event data rather than merely describing a desired financial or social outcome.

The disclosure includes hash-only settlement and privacy-preserving audit. This feature contributes to the technical character of the invention because it changes how processors validate, store, index, mint, route, and reconcile behavioral event data rather than merely describing a desired financial or social outcome.

### XVII. Drawing Support for Claims

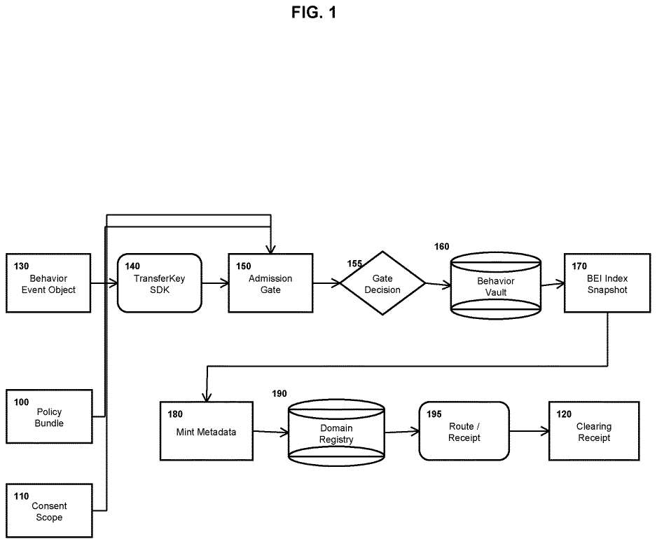

FIG. 1 supports claim drafting by showing a concrete data flow, module dependency, input-output relationship, state transition, data structure, receipt object, permission relationship, or routing relationship used in at least one independent or dependent claim. The drawing may be implemented with alternative shapes, labels, or reference numerals without changing the disclosed technical relationship.

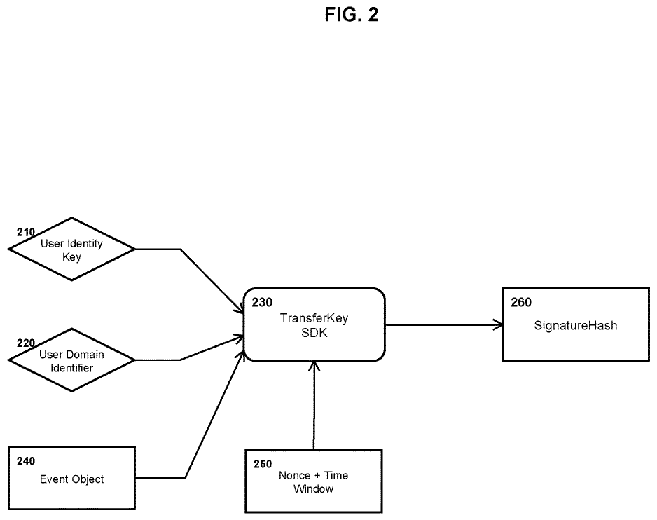

FIG. 2 supports claim drafting by showing a concrete data flow, module dependency, input-output relationship, state transition, data structure, receipt object, permission relationship, or routing relationship used in at least one independent or dependent claim. The drawing may be implemented with alternative shapes, labels, or reference numerals without changing the disclosed technical relationship.

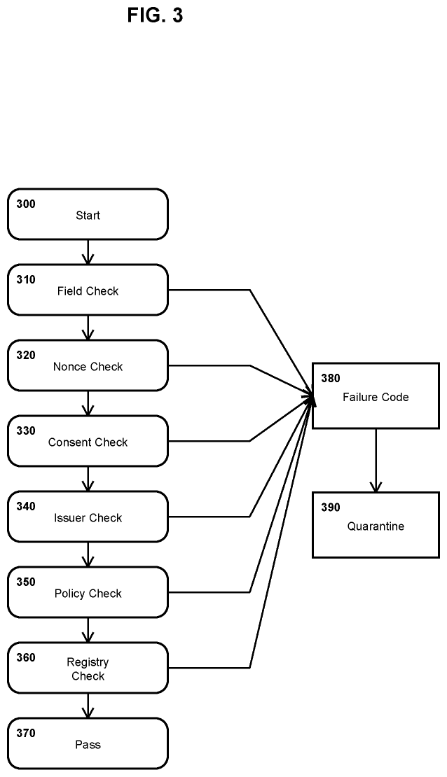

FIG. 3 supports claim drafting by showing a concrete data flow, module dependency, input-output relationship, state transition, data structure, receipt object, permission relationship, or routing relationship used in at least one independent or dependent claim. The drawing may be implemented with alternative shapes, labels, or reference numerals without changing the disclosed technical relationship.

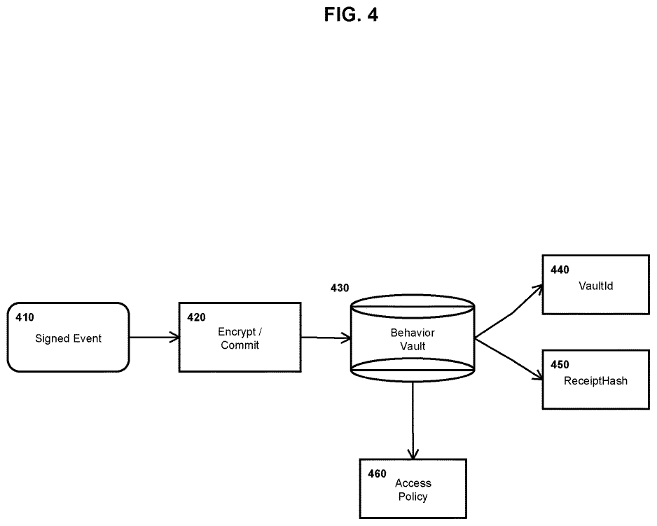

FIG. 4 supports claim drafting by showing a concrete data flow, module dependency, input-output relationship, state transition, data structure, receipt object, permission relationship, or routing relationship used in at least one independent or dependent claim. The drawing may be implemented with alternative shapes, labels, or reference numerals without changing the disclosed technical relationship.

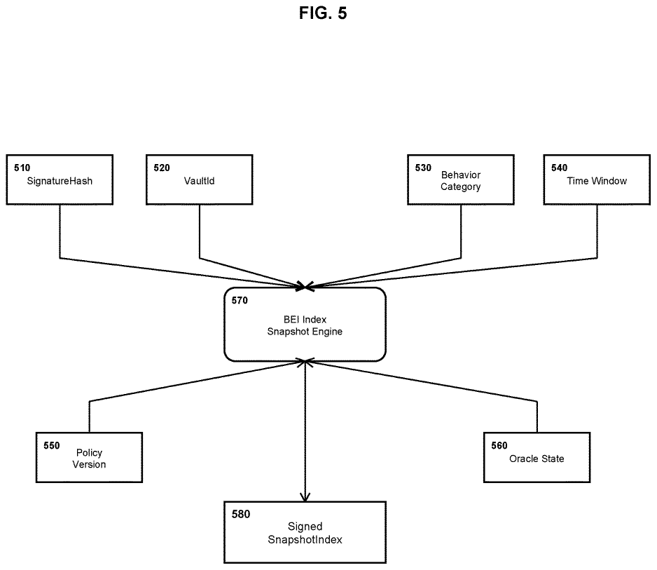

FIG. 5 supports claim drafting by showing a concrete data flow, module dependency, input-output relationship, state transition, data structure, receipt object, permission relationship, or routing relationship used in at least one independent or dependent claim. The drawing may be implemented with alternative shapes, labels, or reference numerals without changing the disclosed technical relationship.

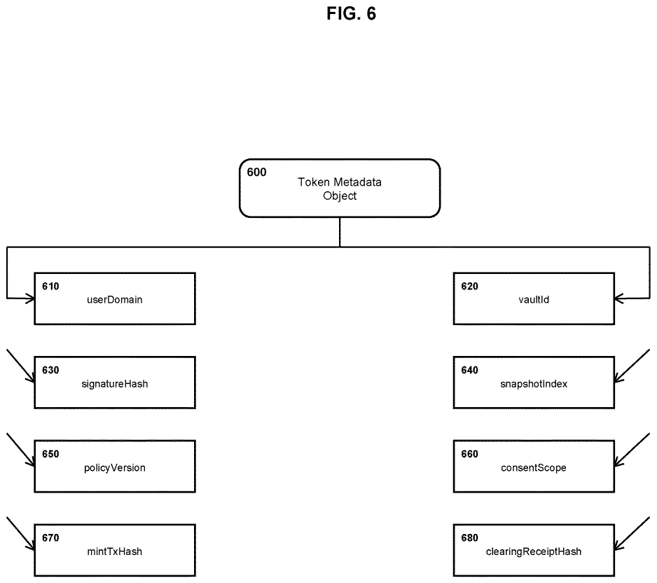

FIG. 6 supports claim drafting by showing a concrete data flow, module dependency, input-output relationship, state transition, data structure, receipt object, permission relationship, or routing relationship used in at least one independent or dependent claim. The drawing may be implemented with alternative shapes, labels, or reference numerals without changing the disclosed technical relationship.

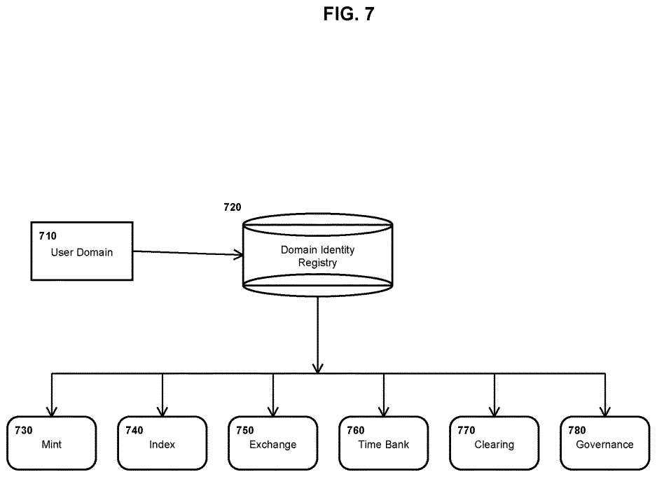

FIG. 7 supports claim drafting by showing a concrete data flow, module dependency, input-output relationship, state transition, data structure, receipt object, permission relationship, or routing relationship used in at least one independent or dependent claim. The drawing may be implemented with alternative shapes, labels, or reference numerals without changing the disclosed technical relationship.

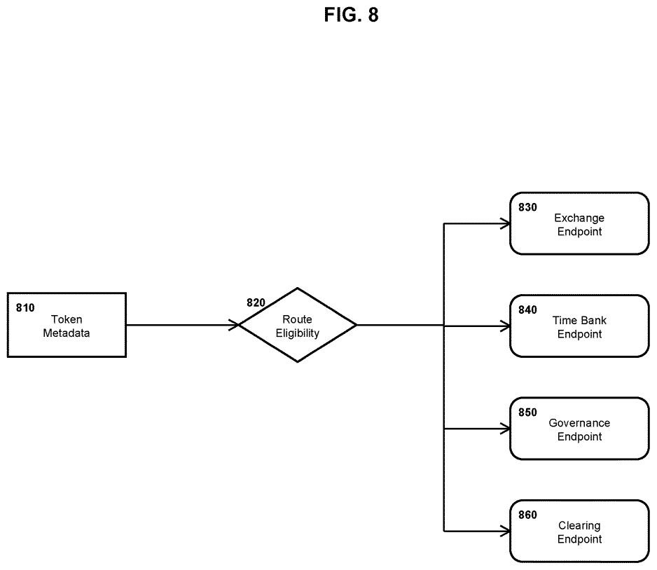

FIG. 8 supports claim drafting by showing a concrete data flow, module dependency, input-output relationship, state transition, data structure, receipt object, permission relationship, or routing relationship used in at least one independent or dependent claim. The drawing may be implemented with alternative shapes, labels, or reference numerals without changing the disclosed technical relationship.

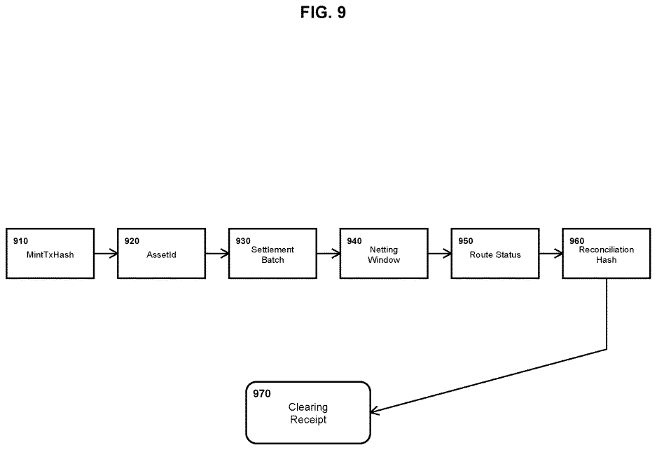

FIG. 9 supports claim drafting by showing a concrete data flow, module dependency, input-output relationship, state transition, data structure, receipt object, permission relationship, or routing relationship used in at least one independent or dependent claim. The drawing may be implemented with alternative shapes, labels, or reference numerals without changing the disclosed technical relationship.

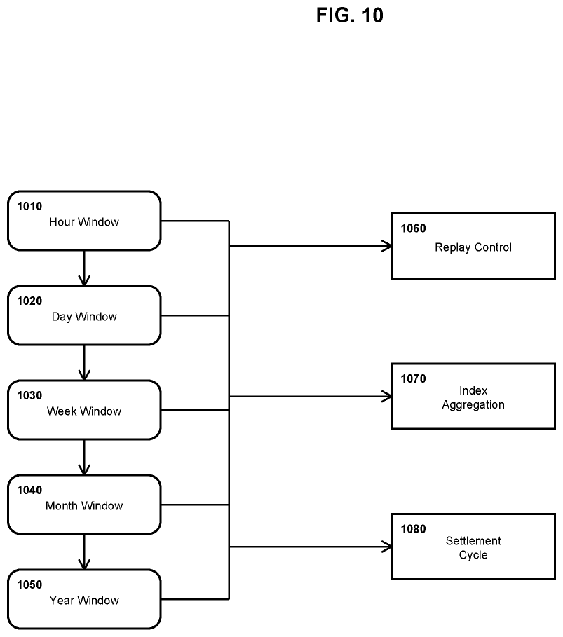

FIG. 10 supports claim drafting by showing a concrete data flow, module dependency, input-output relationship, state transition, data structure, receipt object, permission relationship, or routing relationship used in at least one independent or dependent claim. The drawing may be implemented with alternative shapes, labels, or reference numerals without changing the disclosed technical relationship.

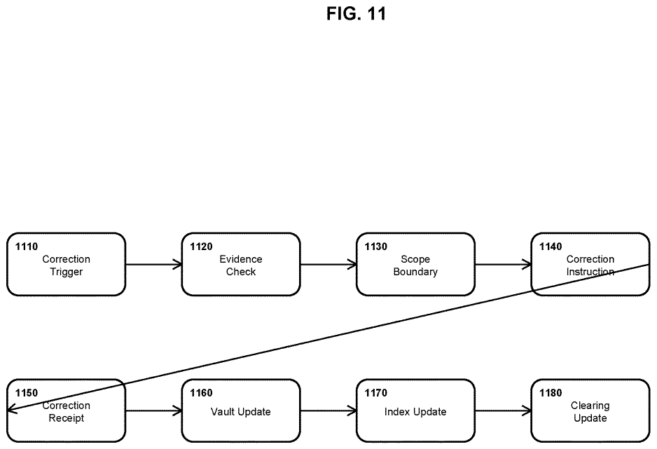

FIG. 11 supports claim drafting by showing a concrete data flow, module dependency, input-output relationship, state transition, data structure, receipt object, permission relationship, or routing relationship used in at least one independent or dependent claim. The drawing may be implemented with alternative shapes, labels, or reference numerals without changing the disclosed technical relationship.

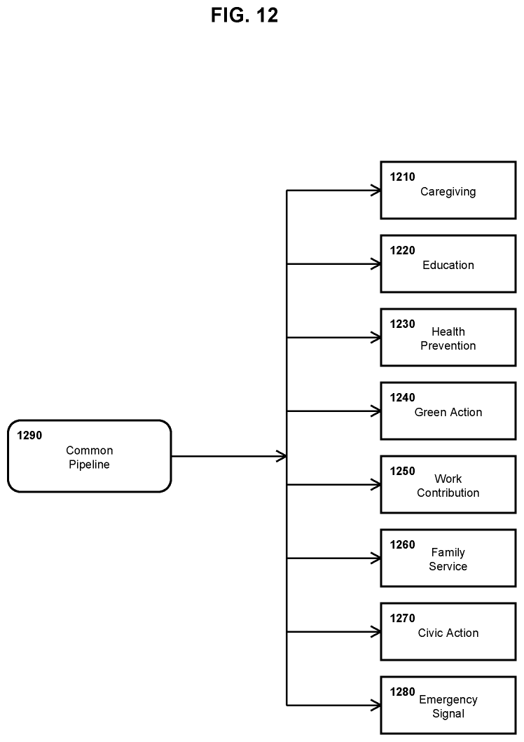

FIG. 12 supports claim drafting by showing a concrete data flow, module dependency, input-output relationship, state transition, data structure, receipt object, permission relationship, or routing relationship used in at least one independent or dependent claim. The drawing may be implemented with alternative shapes, labels, or reference numerals without changing the disclosed technical relationship.

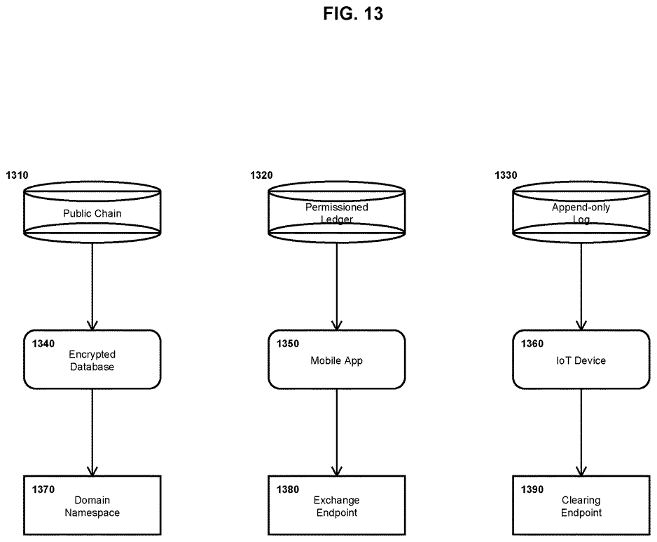

FIG. 13 supports claim drafting by showing a concrete data flow, module dependency, input-output relationship, state transition, data structure, receipt object, permission relationship, or routing relationship used in at least one independent or dependent claim. The drawing may be implemented with alternative shapes, labels, or reference numerals without changing the disclosed technical relationship.

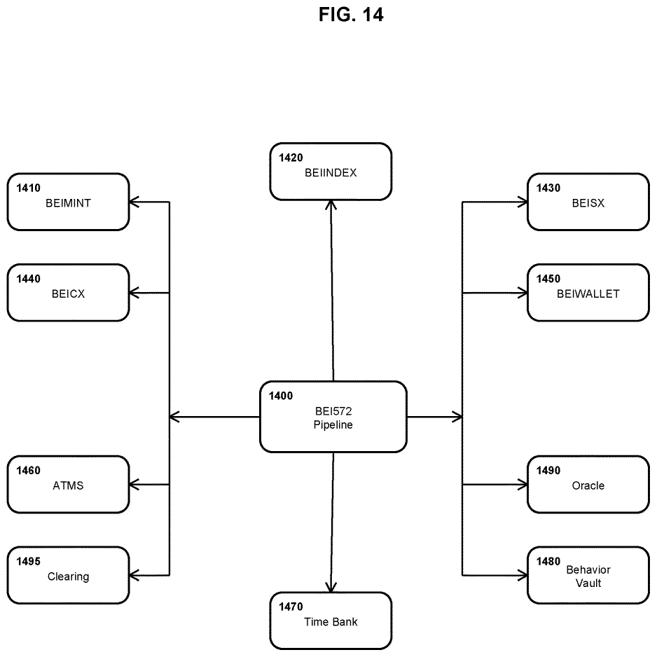

FIG. 14 supports claim drafting by showing a concrete data flow, module dependency, input-output relationship, state transition, data structure, receipt object, permission relationship, or routing relationship used in at least one independent or dependent claim. The drawing may be implemented with alternative shapes, labels, or reference numerals without changing the disclosed technical relationship.

### XVIII. CLAIM ELEMENT SUPPORT MATRIX

Claim support for behavioral event interface. The specification supports behavioral event interface because the disclosed pipeline receives structured event objects and normalizes them so that every later operation uses the same event identifier, behavior category, time-window identifier, consent scope, and evidence commitment. The element has a defined input, a defined output, and a downstream technical consequence.

Claim support for event identifier. The specification supports event identifier because the disclosed pipeline creates a persistent object reference for audit, replay prevention, vault storage, index snapshot generation, mint transaction linkage, and clearing reconciliation. The element has a defined input, a defined output, and a downstream technical consequence.

Claim support for timestamp and time-window identifier. The specification supports timestamp and time-window identifier because the disclosed pipeline defines the temporal boundary used by nonce consumption, rate limits, mint caps, index snapshot effective time, and clearing netting windows. The element has a defined input, a defined output, and a downstream technical consequence.

Claim support for behavior category. The specification supports behavior category because the disclosed pipeline selects policy bundle rules, category weights, source requirements, transfer restrictions, and time-bank or exchange route eligibility. The element has a defined input, a defined output, and a downstream technical consequence.

Claim support for context field. The specification supports context field because the disclosed pipeline captures application, device, location approximation, institutional source, household node, workplace terminal, or service context without requiring public disclosure of private data. The element has a defined input, a defined output, and a downstream technical consequence.

Claim support for consent scope. The specification supports consent scope because the disclosed pipeline controls which fields may be stored, indexed, minted, shared, routed, listed, cleared, delegated, or used for governance. The element has a defined input, a defined output, and a downstream technical consequence.

Claim support for evidence commitment. The specification supports evidence commitment because the disclosed pipeline links the event to underlying evidence by hash, Merkle root, verifiable credential reference, signed attestation, encrypted pointer, or selective proof. The element has a defined input, a defined output, and a downstream technical consequence.

Claim support for TransferKey SDK. The specification supports TransferKey SDK because the disclosed pipeline performs identity-bound signing and returns a signature hash that is required by the vault, index snapshot engine, minting engine, registry resolver, and clearing router. The element has a defined input, a defined output, and a downstream technical consequence.

Claim support for user identity key. The specification supports user identity key because the disclosed pipeline binds the behavioral event object to an identity anchor without limiting the invention to a particular wallet, DID method, certificate system, or blockchain account. The element has a defined input, a defined output, and a downstream technical consequence.

Claim support for user domain identifier. The specification supports user domain identifier because the disclosed pipeline links behavioral assets to a domain, subdomain, namespace basepoint, decentralized name, non-transferable identity token, account-bound token, or equivalent registry object. The element has a defined input, a defined output, and a downstream technical consequence.

Claim support for Admission Gate state machine. The specification supports Admission Gate state machine because the disclosed pipeline converts eligibility into deterministic states rather than discretionary post-hoc review, thereby preventing minting from proceeding unless required conditions are satisfied. The element has a defined input, a defined output, and a downstream technical consequence.

Claim support for nonce uniqueness. The specification supports nonce uniqueness because the disclosed pipeline prevents double-use or replay of a behavioral event within or across time windows. The element has a defined input, a defined output, and a downstream technical consequence.

Claim support for issuer authorization. The specification supports issuer authorization because the disclosed pipeline requires the event source to be authorized under a signed policy bundle or registry endpoint record before minting. The element has a defined input, a defined output, and a downstream technical consequence.

Claim support for policy-version eligibility. The specification supports policy-version eligibility because the disclosed pipeline ensures that minting and routing use rules effective at a defined time, and that historical assets retain their prior policy references. The element has a defined input, a defined output, and a downstream technical consequence.

Claim support for encrypted behavioral vault. The specification supports encrypted behavioral vault because the disclosed pipeline stores encrypted payloads or commitments and returns a vault identifier and receipt hash consumed by later modules. The element has a defined input, a defined output, and a downstream technical consequence.

Claim support for vault identifier. The specification supports vault identifier because the disclosed pipeline provides a stable reference allowing token metadata, index snapshots, clearing receipts, and audit records to locate the associated evidence commitment without exposing raw data. The element has a defined input, a defined output, and a downstream technical consequence.

Claim support for receipt hash. The specification supports receipt hash because the disclosed pipeline proves that a vault or clearing event occurred with the stated fields and allows independent verification through tamper-evident structures. The element has a defined input, a defined output, and a downstream technical consequence.

Claim support for BEI index snapshot engine. The specification supports BEI index snapshot engine because the disclosed pipeline computes a signed snapshot representing a behavior-value state at a defined policy version and time window. The element has a defined input, a defined output, and a downstream technical consequence.

Claim support for signed index snapshot. The specification supports signed index snapshot because the disclosed pipeline freezes a provenance and valuation state so later price quotes or index recalibrations cannot rewrite the original evidence chain. The element has a defined input, a defined output, and a downstream technical consequence.

Claim support for minting engine. The specification supports minting engine because the disclosed pipeline creates token metadata only after upstream objects have been validated and mutually bound. The element has a defined input, a defined output, and a downstream technical consequence.

Claim support for token metadata. The specification supports token metadata because the disclosed pipeline binds userDomain, vaultId, signatureHash, snapshotIndex, policyVersion, consentScope, mintTxHash, and clearingReceiptHash into a single auditable asset object. The element has a defined input, a defined output, and a downstream technical consequence.

Claim support for domain identity registry. The specification supports domain identity registry because the disclosed pipeline maps identity and domain control to permissions for vault access, minting, governance, index calibration, listing, time-bank routing, and clearing. The element has a defined input, a defined output, and a downstream technical consequence.

Claim support for signed endpoint records. The specification supports signed endpoint records because the disclosed pipeline allows mint, proof, policy, index, exchange, time-bank, governance, and clearing endpoints to be discovered and verified. The element has a defined input, a defined output, and a downstream technical consequence.

Claim support for exchange or clearing routing engine. The specification supports exchange or clearing routing engine because the disclosed pipeline converts a minted behavioral asset into a routed asset with listing status, time-bank status, governance status, settlement batch, reconciliation hash, or clearing receipt. The element has a defined input, a defined output, and a downstream technical consequence.

Claim support for mutual consistency requirement. The specification supports mutual consistency requirement because the disclosed pipeline prevents the system from producing a completed asset when the signature hash, vault identifier, signed index snapshot, or user domain identifier do not match. The element has a defined input, a defined output, and a downstream technical consequence.

### XIX. ENDPOINT RECORD AND DOMAIN ROUTING IMPLEMENTATIONS

Signed endpoint field endpointRole. A signed endpoint record may include a field named endpointRole or an equivalent field. The field may be used to verify that a domain identity registry record can route a mint, proof, policy, index, exchange, time-bank, governance, audit, or clearing operation to an authorized endpoint.

Signed endpoint field endpointUri. A signed endpoint record may include a field named endpointUri or an equivalent field. The field may be used to verify that a domain identity registry record can route a mint, proof, policy, index, exchange, time-bank, governance, audit, or clearing operation to an authorized endpoint.

Signed endpoint field publicKeyId. A signed endpoint record may include a field named publicKeyId or an equivalent field. The field may be used to verify that a domain identity registry record can route a mint, proof, policy, index, exchange, time-bank, governance, audit, or clearing operation to an authorized endpoint.

Signed endpoint field keyVersion. A signed endpoint record may include a field named keyVersion or an equivalent field. The field may be used to verify that a domain identity registry record can route a mint, proof, policy, index, exchange, time-bank, governance, audit, or clearing operation to an authorized endpoint.

Signed endpoint field policyVersion. A signed endpoint record may include a field named policyVersion or an equivalent field. The field may be used to verify that a domain identity registry record can route a mint, proof, policy, index, exchange, time-bank, governance, audit, or clearing operation to an authorized endpoint.

Signed endpoint field validityWindow. A signed endpoint record may include a field named validityWindow or an equivalent field. The field may be used to verify that a domain identity registry record can route a mint, proof, policy, index, exchange, time-bank, governance, audit, or clearing operation to an authorized endpoint.

Signed endpoint field routeClass. A signed endpoint record may include a field named routeClass or an equivalent field. The field may be used to verify that a domain identity registry record can route a mint, proof, policy, index, exchange, time-bank, governance, audit, or clearing operation to an authorized endpoint.

Signed endpoint field jurisdictionProfile. A signed endpoint record may include a field named jurisdictionProfile or an equivalent field. The field may be used to verify that a domain identity registry record can route a mint, proof, policy, index, exchange, time-bank, governance, audit, or clearing operation to an authorized endpoint.

Signed endpoint field revocationStatus. A signed endpoint record may include a field named revocationStatus or an equivalent field. The field may be used to verify that a domain identity registry record can route a mint, proof, policy, index, exchange, time-bank, governance, audit, or clearing operation to an authorized endpoint.

Signed endpoint field signature. A signed endpoint record may include a field named signature or an equivalent field. The field may be used to verify that a domain identity registry record can route a mint, proof, policy, index, exchange, time-bank, governance, audit, or clearing operation to an authorized endpoint.

Signed endpoint field certificateBinding. A signed endpoint record may include a field named certificateBinding or an equivalent field. The field may be used to verify that a domain identity registry record can route a mint, proof, policy, index, exchange, time-bank, governance, audit, or clearing operation to an authorized endpoint.

Signed endpoint field domainControlProof. A signed endpoint record may include a field named domainControlProof or an equivalent field. The field may be used to verify that a domain identity registry record can route a mint, proof, policy, index, exchange, time-bank, governance, audit, or clearing operation to an authorized endpoint.

Signed endpoint field fallbackRoute. A signed endpoint record may include a field named fallbackRoute or an equivalent field. The field may be used to verify that a domain identity registry record can route a mint, proof, policy, index, exchange, time-bank, governance, audit, or clearing operation to an authorized endpoint.

Signed endpoint field auditEndpoint. A signed endpoint record may include a field named auditEndpoint or an equivalent field. The field may be used to verify that a domain identity registry record can route a mint, proof, policy, index, exchange, time-bank, governance, audit, or clearing operation to an authorized endpoint.

Signed endpoint field clearingMemberId. A signed endpoint record may include a field named clearingMemberId or an equivalent field. The field may be used to verify that a domain identity registry record can route a mint, proof, policy, index, exchange, time-bank, governance, audit, or clearing operation to an authorized endpoint.

Endpoint resolution may occur through DNS records, DNSSEC records, DANE bindings, HTTPS records, DID documents, verifiable credentials, registry APIs, ledger events, smart contract calls, or a hybrid of such mechanisms. The invention is not limited to a particular naming system so long as the endpoint record is verifiable and policy-bounded.

A domain basepoint may be configured as an identity basepoint, mint basepoint, index basepoint, wallet basepoint, time-bank basepoint, exchange basepoint, clearing basepoint, governance basepoint, or audit basepoint. A subdomain may inherit policy defaults from a parent basepoint while publishing its own endpoint record for a specific function or time window.

Endpoint rotation may be performed by publishing a new signed endpoint record with a new key version, new effective time window, or new policy version. Previously minted assets may retain historical endpoint references for audit, while new assets use the currently effective endpoint record.

Endpoint revocation may cause the Admission Gate, minting engine, exchange router, or clearing router to issue a failure code or quarantine state. Revocation does not require deletion of earlier vault receipts or clearing receipts; rather, revocation is recorded as a state that preserves evidentiary continuity.

### XX. DETAILED TRANSACTION LIFE CYCLE EXAMPLES

Ordinary mint life cycle. In a non-limiting ordinary mint implementation, an authorized source submits a behavior event; the SDK signs; the Admission Gate passes; the vault returns a receipt; the index engine signs a snapshot; the minting engine creates metadata; the router deposits the asset into a wallet endpoint. Each stage has a defined input and output, and each output may be stored as a data object, receipt hash, status code, policy reference, or reconciliation identifier.

Ordinary mint audit trail. The audit trail for the ordinary mint implementation can include eventId, signatureHash, gateState, vaultId, receiptHash, snapshotIndex, policyVersion, userDomain, mintTxHash, routeStatus, and clearingReceiptHash. The audit trail can be verified without exposing raw behavioral payloads when commitments or selective proofs are sufficient.

Time-bank deposit life cycle. In a non-limiting time-bank deposit implementation, a time-denominated asset is routed to a time-bank endpoint, where the clearing router assigns a deposit status, netting window, account credit state, and reconciliation hash. Each stage has a defined input and output, and each output may be stored as a data object, receipt hash, status code, policy reference, or reconciliation identifier.

Time-bank deposit audit trail. The audit trail for the time-bank deposit implementation can include eventId, signatureHash, gateState, vaultId, receiptHash, snapshotIndex, policyVersion, userDomain, mintTxHash, routeStatus, and clearingReceiptHash. The audit trail can be verified without exposing raw behavioral payloads when commitments or selective proofs are sufficient.

Exchange listing life cycle. In a non-limiting exchange listing implementation, a transfer-eligible asset is routed to an exchange endpoint, where the router checks listing rules, signed index snapshot, vault receipt status, and registry permissions before creating a listing-admission record or rejection record. Each stage has a defined input and output, and each output may be stored as a data object, receipt hash, status code, policy reference, or reconciliation identifier.

Exchange listing audit trail. The audit trail for the exchange listing implementation can include eventId, signatureHash, gateState, vaultId, receiptHash, snapshotIndex, policyVersion, userDomain, mintTxHash, routeStatus, and clearingReceiptHash. The audit trail can be verified without exposing raw behavioral payloads when commitments or selective proofs are sufficient.

Clearing settlement life cycle. In a non-limiting clearing settlement implementation, a matched or redeemed asset is sent to a clearing endpoint, where the clearing router generates settlement batch identifiers, reconciliation hashes, final receipt hashes, and exception states. Each stage has a defined input and output, and each output may be stored as a data object, receipt hash, status code, policy reference, or reconciliation identifier.

Clearing settlement audit trail. The audit trail for the clearing settlement implementation can include eventId, signatureHash, gateState, vaultId, receiptHash, snapshotIndex, policyVersion, userDomain, mintTxHash, routeStatus, and clearingReceiptHash. The audit trail can be verified without exposing raw behavioral payloads when commitments or selective proofs are sufficient.

Governance vote life cycle. In a non-limiting governance vote implementation, a domain-controlled governance event is signed and vaulted as a behavior event; the index snapshot records the governance category; the registry grants only policy voting or index calibration review permissions. Each stage has a defined input and output, and each output may be stored as a data object, receipt hash, status code, policy reference, or reconciliation identifier.

Governance vote audit trail. The audit trail for the governance vote implementation can include eventId, signatureHash, gateState, vaultId, receiptHash, snapshotIndex, policyVersion, userDomain, mintTxHash, routeStatus, and clearingReceiptHash. The audit trail can be verified without exposing raw behavioral payloads when commitments or selective proofs are sufficient.

Audit-only preservation life cycle. In a non-limiting audit-only preservation implementation, a sensitive behavior event is signed and vaulted, and the index engine may generate an internal snapshot, but the policy bundle prevents minting of a transferable asset. Each stage has a defined input and output, and each output may be stored as a data object, receipt hash, status code, policy reference, or reconciliation identifier.

Audit-only preservation audit trail. The audit trail for the audit-only preservation implementation can include eventId, signatureHash, gateState, vaultId, receiptHash, snapshotIndex, policyVersion, userDomain, mintTxHash, routeStatus, and clearingReceiptHash. The audit trail can be verified without exposing raw behavioral payloads when commitments or selective proofs are sufficient.

Quarantine path life cycle. In a non-limiting quarantine path implementation, an anomaly score or issuer inconsistency causes the Admission Gate to issue a failure code and quarantine state, preserving the evidence commitment without producing a completed mint metadata object. Each stage has a defined input and output, and each output may be stored as a data object, receipt hash, status code, policy reference, or reconciliation identifier.

Quarantine path audit trail. The audit trail for the quarantine path implementation can include eventId, signatureHash, gateState, vaultId, receiptHash, snapshotIndex, policyVersion, userDomain, mintTxHash, routeStatus, and clearingReceiptHash. The audit trail can be verified without exposing raw behavioral payloads when commitments or selective proofs are sufficient.

Post-mint repricing life cycle. In a non-limiting post-mint repricing implementation, an exchange quote changes after minting, but the original signed index snapshot remains tied to the asset so that later pricing does not rewrite historical provenance. Each stage has a defined input and output, and each output may be stored as a data object, receipt hash, status code, policy reference, or reconciliation identifier.

Post-mint repricing audit trail. The audit trail for the post-mint repricing implementation can include eventId, signatureHash, gateState, vaultId, receiptHash, snapshotIndex, policyVersion, userDomain, mintTxHash, routeStatus, and clearingReceiptHash. The audit trail can be verified without exposing raw behavioral payloads when commitments or selective proofs are sufficient.

Inheritance delegation life cycle. In a non-limiting inheritance delegation implementation, a vault owner assigns viewing rights and settlement rights to different successors while preserving signing authority and transfer authority as separate registry permissions. Each stage has a defined input and output, and each output may be stored as a data object, receipt hash, status code, policy reference, or reconciliation identifier.

Inheritance delegation audit trail. The audit trail for the inheritance delegation implementation can include eventId, signatureHash, gateState, vaultId, receiptHash, snapshotIndex, policyVersion, userDomain, mintTxHash, routeStatus, and clearingReceiptHash. The audit trail can be verified without exposing raw behavioral payloads when commitments or selective proofs are sufficient.

Cross-jurisdiction route life cycle. In a non-limiting cross-jurisdiction route implementation, a behavioral asset generated under a first policy profile is routed to a second jurisdiction only if both policy bundles and the registry authorize the route and a clearing receipt records the cross-route reconciliation. Each stage has a defined input and output, and each output may be stored as a data object, receipt hash, status code, policy reference, or reconciliation identifier.

Cross-jurisdiction route audit trail. The audit trail for the cross-jurisdiction route implementation can include eventId, signatureHash, gateState, vaultId, receiptHash, snapshotIndex, policyVersion, userDomain, mintTxHash, routeStatus, and clearingReceiptHash. The audit trail can be verified without exposing raw behavioral payloads when commitments or selective proofs are sufficient.

### XXI. API AND MESSAGE INTERFACE EMBODIMENTS

BehaviorSubmitRequest. A message or interface object named BehaviorSubmitRequest or an equivalent object may include eventId, userDomain, issuerId, timeWindowId, behaviorCategory, contextVector, consentScope, evidenceCommitment, nonce, and policyVersion. The object may be transmitted over REST, RPC, message queue, smart contract event, ledger transaction, wallet call, or enterprise API, and may be signed, encrypted, hashed, or selectively disclosed according to policy.

SignatureResponse. A message or interface object named SignatureResponse or an equivalent object may include signatureHash, publicKeyId, domainBindingHash, timeWindowId, nonceStatus, and verificationStatus. The object may be transmitted over REST, RPC, message queue, smart contract event, ledger transaction, wallet call, or enterprise API, and may be signed, encrypted, hashed, or selectively disclosed according to policy.

GateDecisionResponse. A message or interface object named GateDecisionResponse or an equivalent object may include passFlag, failureCode, quarantineStatus, reviewRequired, policyRule, and gateTimestamp. The object may be transmitted over REST, RPC, message queue, smart contract event, ledger transaction, wallet call, or enterprise API, and may be signed, encrypted, hashed, or selectively disclosed according to policy.

VaultCommitmentResponse. A message or interface object named VaultCommitmentResponse or an equivalent object may include vaultId, receiptHash, payloadCommitment, accessPolicyHash, retentionClass, and revocationState. The object may be transmitted over REST, RPC, message queue, smart contract event, ledger transaction, wallet call, or enterprise API, and may be signed, encrypted, hashed, or selectively disclosed according to policy.

IndexSnapshotResponse. A message or interface object named IndexSnapshotResponse or an equivalent object may include snapshotIndex, indexVersion, effectiveTime, categoryWeight, sourceScore, tierFactor, anomalyFlag, oracleSignature, and snapshotHash. The object may be transmitted over REST, RPC, message queue, smart contract event, ledger transaction, wallet call, or enterprise API, and may be signed, encrypted, hashed, or selectively disclosed according to policy.

MintRequest. A message or interface object named MintRequest or an equivalent object may include userDomain, vaultId, signatureHash, snapshotIndex, policyVersion, consentScope, assetType, and routeClass. The object may be transmitted over REST, RPC, message queue, smart contract event, ledger transaction, wallet call, or enterprise API, and may be signed, encrypted, hashed, or selectively disclosed according to policy.

MintResponse. A message or interface object named MintResponse or an equivalent object may include tokenId, mintTxHash, tokenMetadataHash, transferMode, registryVersion, and routeEligibility. The object may be transmitted over REST, RPC, message queue, smart contract event, ledger transaction, wallet call, or enterprise API, and may be signed, encrypted, hashed, or selectively disclosed according to policy.

RouteRequest. A message or interface object named RouteRequest or an equivalent object may include tokenId, userDomain, snapshotIndex, mintTxHash, requestedEndpointRole, policyVersion, and consentScope. The object may be transmitted over REST, RPC, message queue, smart contract event, ledger transaction, wallet call, or enterprise API, and may be signed, encrypted, hashed, or selectively disclosed according to policy.

RouteResponse. A message or interface object named RouteResponse or an equivalent object may include routeStatus, endpointId, clearingMemberId, nettingWindow, settlementBatchId, reconciliationHash, and clearingReceiptHash. The object may be transmitted over REST, RPC, message queue, smart contract event, ledger transaction, wallet call, or enterprise API, and may be signed, encrypted, hashed, or selectively disclosed according to policy.

ExceptionMessage. A message or interface object named ExceptionMessage or an equivalent object may include failureCode, exceptionStatus, reviewRoute, quarantinePeriod, correctionPointer, and auditReceiptHash. The object may be transmitted over REST, RPC, message queue, smart contract event, ledger transaction, wallet call, or enterprise API, and may be signed, encrypted, hashed, or selectively disclosed according to policy.

### XXII. DATABASE, LEDGER, AND TABLE EMBODIMENTS

Capture Table. The system may implement a capture table or equivalent object store, event stream, ledger schema, document database collection, append-only log, or Merkle tree with fields including sourceType, sourceKey, deviceState, behaviorCategory, eventTime, contextVector, consentScope, evidenceCommitment, and policyVersion. Each row or record may store a policy version and time-window identifier so that later audit can determine which rules applied at the relevant stage.

Capture Table linkage. A capture table may store a hash pointer to an upstream or downstream pipeline object, thereby demonstrating transaction volume, index usage, vault usage, domain registry binding, route usage, and clearing usage without exposing private behavioral payloads.

Signature Table. The system may implement a signature table or equivalent object store, event stream, ledger schema, document database collection, append-only log, or Merkle tree with fields including signatureHash, signerKey, domainBindingHash, nonce, timeWindowId, signatureAlgorithm, and verificationStatus. Each row or record may store a policy version and time-window identifier so that later audit can determine which rules applied at the relevant stage.

Signature Table linkage. A signature table may store a hash pointer to an upstream or downstream pipeline object, thereby demonstrating transaction volume, index usage, vault usage, domain registry binding, route usage, and clearing usage without exposing private behavioral payloads.

Gate Table. The system may implement a gate table or equivalent object store, event stream, ledger schema, document database collection, append-only log, or Merkle tree with fields including gateName, passFlag, failureCode, policyRule, timestamp, reviewRequired, and quarantineStatus. Each row or record may store a policy version and time-window identifier so that later audit can determine which rules applied at the relevant stage.

Gate Table linkage. A gate table may store a hash pointer to an upstream or downstream pipeline object, thereby demonstrating transaction volume, index usage, vault usage, domain registry binding, route usage, and clearing usage without exposing private behavioral payloads.

Vault Table. The system may implement a vault table or equivalent object store, event stream, ledger schema, document database collection, append-only log, or Merkle tree with fields including vaultId, receiptHash, payloadCommitment, accessPolicyHash, revocationState, retentionClass, and auditPointer. Each row or record may store a policy version and time-window identifier so that later audit can determine which rules applied at the relevant stage.

Vault Table linkage. A vault table may store a hash pointer to an upstream or downstream pipeline object, thereby demonstrating transaction volume, index usage, vault usage, domain registry binding, route usage, and clearing usage without exposing private behavioral payloads.

Index Table. The system may implement an index table or equivalent object store, event stream, ledger schema, document database collection, append-only log, or Merkle tree with fields including snapshotIndex, formulaId, oracleState, categoryWeight, sourceScore, tierFactor, policyVersion, and effectiveTime. Each row or record may store a policy version and time-window identifier so that later audit can determine which rules applied at the relevant stage.

Index Table linkage. An index table may store a hash pointer to an upstream or downstream pipeline object, thereby demonstrating transaction volume, index usage, vault usage, domain registry binding, route usage, and clearing usage without exposing private behavioral payloads.

Mint Table. The system may implement a mint table or equivalent object store, event stream, ledger schema, document database collection, append-only log, or Merkle tree with fields including tokenId, assetType, userDomain, vaultId, signatureHash, snapshotIndex, policyVersion, consentScope, mintTxHash, and transferMode. Each row or record may store a policy version and time-window identifier so that later audit can determine which rules applied at the relevant stage.

Mint Table linkage. A mint table may store a hash pointer to an upstream or downstream pipeline object, thereby demonstrating transaction volume, index usage, vault usage, domain registry binding, route usage, and clearing usage without exposing private behavioral payloads.

Registry Table. The system may implement a registry table or equivalent object store, event stream, ledger schema, document database collection, append-only log, or Merkle tree with fields including userDomain, identityAnchor, vaultRoute, mintRoute, indexRoute, exchangeRoute, clearingRoute, governanceRoute, and endpointSignature. Each row or record may store a policy version and time-window identifier so that later audit can determine which rules applied at the relevant stage.

Registry Table linkage. A registry table may store a hash pointer to an upstream or downstream pipeline object, thereby demonstrating transaction volume, index usage, vault usage, domain registry binding, route usage, and clearing usage without exposing private behavioral payloads.

Settlement Table. The system may implement a settlement table or equivalent object store, event stream, ledger schema, document database collection, append-only log, or Merkle tree with fields including assetId, counterparty, nettingWindow, batchId, settlementRoute, statusCode, reconciliationHash, and clearingReceiptHash. Each row or record may store a policy version and time-window identifier so that later audit can determine which rules applied at the relevant stage.

Settlement Table linkage. A settlement table may store a hash pointer to an upstream or downstream pipeline object, thereby demonstrating transaction volume, index usage, vault usage, domain registry binding, route usage, and clearing usage without exposing private behavioral payloads.

### XXIII. FORMULA, RULE, AND ORACLE EMBODIMENTS

IndexScore. A non-limiting computation may be represented as baseWeight*sourceScore*tierFactor*timeWindowFactor*anomalyAdjustment. The expression is illustrative and may be replaced by equivalent formulas, rules, lookup tables, machine-learning outputs, oracle-assisted calculations, or governance-approved coefficients under a signed policy bundle.

BehaviorValueRatio. A non-limiting computation may be represented as verifiedBehaviorUnits/eligibleMintCapacity. The expression is illustrative and may be replaced by equivalent formulas, rules, lookup tables, machine-learning outputs, oracle-assisted calculations, or governance-approved coefficients under a signed policy bundle.

MintEligibility. A non-limiting computation may be represented as AdmissionGatePassed AND VaultCommitted AND SnapshotSigned AND DomainPermissionValid. The expression is illustrative and may be replaced by equivalent formulas, rules, lookup tables, machine-learning outputs, oracle-assisted calculations, or governance-approved coefficients under a signed policy bundle.

ClearingEligibility. A non-limiting computation may be represented as MintedAssetValid AND ListingPolicyValid AND SettlementRouteActive. The expression is illustrative and may be replaced by equivalent formulas, rules, lookup tables, machine-learning outputs, oracle-assisted calculations, or governance-approved coefficients under a signed policy bundle.

VaultIntegrity. A non-limiting computation may be represented as hash(encryptedPayload)==payloadCommitment AND hash(receiptFields)==receiptHash. The expression is illustrative and may be replaced by equivalent formulas, rules, lookup tables, machine-learning outputs, oracle-assisted calculations, or governance-approved coefficients under a signed policy bundle.

SnapshotIntegrity. A non-limiting computation may be represented as signature(indexEngineKey, snapshotPayload) verifies under policyVersion. The expression is illustrative and may be replaced by equivalent formulas, rules, lookup tables, machine-learning outputs, oracle-assisted calculations, or governance-approved coefficients under a signed policy bundle.

RouteIntegrity. A non-limiting computation may be represented as endpointSignature verifies AND routeStatus is active AND policyVersion is effective. The expression is illustrative and may be replaced by equivalent formulas, rules, lookup tables, machine-learning outputs, oracle-assisted calculations, or governance-approved coefficients under a signed policy bundle.

ReconciliationIntegrity. A non-limiting computation may be represented as hash(mintTxHash, vaultId, snapshotIndex, routeStatus)==reconciliationHash. The expression is illustrative and may be replaced by equivalent formulas, rules, lookup tables, machine-learning outputs, oracle-assisted calculations, or governance-approved coefficients under a signed policy bundle.

### XXIV. DOWNSTREAM INTEROPERABILITY WITHOUT SCOPE SURRENDER

Downstream exchange listing. The disclosed behavioral asset genesis layer may route an asset or receipt toward downstream exchange listing. Such downstream routing is an interoperability output of the present system and does not require that every downstream financial infrastructure module be implemented inside the upstream minting system.

Downstream time-bank deposit. The disclosed behavioral asset genesis layer may route an asset or receipt toward downstream time-bank deposit. Such downstream routing is an interoperability output of the present system and does not require that every downstream financial infrastructure module be implemented inside the upstream minting system.

Downstream clearing reconciliation. The disclosed behavioral asset genesis layer may route an asset or receipt toward downstream clearing reconciliation. Such downstream routing is an interoperability output of the present system and does not require that every downstream financial infrastructure module be implemented inside the upstream minting system.

Downstream settlement-backed index publication. The disclosed behavioral asset genesis layer may route an asset or receipt toward downstream settlement-backed index publication. Such downstream routing is an interoperability output of the present system and does not require that every downstream financial infrastructure module be implemented inside the upstream minting system.

Downstream reserve gate review. The disclosed behavioral asset genesis layer may route an asset or receipt toward downstream reserve gate review. Such downstream routing is an interoperability output of the present system and does not require that every downstream financial infrastructure module be implemented inside the upstream minting system.

Downstream security profile review. The disclosed behavioral asset genesis layer may route an asset or receipt toward downstream security profile review. Such downstream routing is an interoperability output of the present system and does not require that every downstream financial infrastructure module be implemented inside the upstream minting system.

Downstream title or rights recording. The disclosed behavioral asset genesis layer may route an asset or receipt toward downstream title or rights recording. Such downstream routing is an interoperability output of the present system and does not require that every downstream financial infrastructure module be implemented inside the upstream minting system.

Downstream insurance risk pooling. The disclosed behavioral asset genesis layer may route an asset or receipt toward downstream insurance risk pooling. Such downstream routing is an interoperability output of the present system and does not require that every downstream financial infrastructure module be implemented inside the upstream minting system.

Downstream derivative reference formation. The disclosed behavioral asset genesis layer may route an asset or receipt toward downstream derivative reference formation. Such downstream routing is an interoperability output of the present system and does not require that every downstream financial infrastructure module be implemented inside the upstream minting system.

Downstream rollback-ready exception processing. The disclosed behavioral asset genesis layer may route an asset or receipt toward downstream rollback-ready exception processing. Such downstream routing is an interoperability output of the present system and does not require that every downstream financial infrastructure module be implemented inside the upstream minting system.

The upstream system may expose a clearing-ready asset without itself becoming a full clearinghouse. The technical contribution remains the formation of a behavioral digital asset whose metadata, registry permissions, index snapshot, vault receipt, and route status make it ready for later exchange, clearing, settlement, index, reserve, security, title, insurance, derivative, value-return, or rollback processing.

The upstream system may expose a signed index snapshot without itself calculating every downstream market index. The snapshot is a mint-time or policy-time state that can be consumed by later index systems while preserving the asset provenance generated by the present invention.

### XXV. DRAWING-TO-CLAIM MAPPING

FIG. 1 mapping. FIG. 1 supports pipeline elements and claim 11 method sequence. The drawing is not decorative; it identifies data flow, module input, module output, state transition, record binding, or routing relationship used by one or more claims.

FIG. 2 mapping. FIG. 2 supports TransferKey SDK, user identity key, user domain identifier, nonce, time window, and signature hash limitations. The drawing is not decorative; it identifies data flow, module input, module output, state transition, record binding, or routing relationship used by one or more claims.

FIG. 3 mapping. FIG. 3 supports Admission Gate state machine, pass state, failure code, and quarantine limitations. The drawing is not decorative; it identifies data flow, module input, module output, state transition, record binding, or routing relationship used by one or more claims.

FIG. 4 mapping. FIG. 4 supports encrypted behavioral vault, vault identifier, receipt hash, access policy, and commitment limitations. The drawing is not decorative; it identifies data flow, module input, module output, state transition, record binding, or routing relationship used by one or more claims.

FIG. 5 mapping. FIG. 5 supports BEI index snapshot engine, snapshotIndex, oracle state, policy version, and signed snapshot limitations. The drawing is not decorative; it identifies data flow, module input, module output, state transition, record binding, or routing relationship used by one or more claims.

FIG. 6 mapping. FIG. 6 supports token metadata binding userDomain, vaultId, signatureHash, snapshotIndex, policyVersion, consentScope, mintTxHash, and clearingReceiptHash limitations. The drawing is not decorative; it identifies data flow, module input, module output, state transition, record binding, or routing relationship used by one or more claims.

FIG. 7 mapping. FIG. 7 supports domain identity registry, endpoint routing, and governance or clearing permission limitations. The drawing is not decorative; it identifies data flow, module input, module output, state transition, record binding, or routing relationship used by one or more claims.

FIG. 8 mapping. FIG. 8 supports exchange endpoint, time-bank endpoint, governance endpoint, clearing endpoint, and routing limitations. The drawing is not decorative; it identifies data flow, module input, module output, state transition, record binding, or routing relationship used by one or more claims.

FIG. 9 mapping. FIG. 9 supports clearing receipt, settlement batch, netting window, route status, reconciliation hash, and final receipt limitations. The drawing is not decorative; it identifies data flow, module input, module output, state transition, record binding, or routing relationship used by one or more claims.

FIG. 10 mapping. FIG. 10 supports time-window identifiers, replay control, index aggregation, and settlement-cycle limitations. The drawing is not decorative; it identifies data flow, module input, module output, state transition, record binding, or routing relationship used by one or more claims.

FIG. 11 mapping. FIG. 11 supports failure correction, scope boundary, correction receipts, vault update, index update, and clearing update limitations. The drawing is not decorative; it identifies data flow, module input, module output, state transition, record binding, or routing relationship used by one or more claims.

FIG. 12 mapping. FIG. 12 supports field-of-use behavior categories that enter the same common ordered pipeline. The drawing is not decorative; it identifies data flow, module input, module output, state transition, record binding, or routing relationship used by one or more claims.

FIG. 13 mapping. FIG. 13 supports deployment environments and implementation neutrality across ledgers, logs, databases, mobile applications, IoT devices, namespaces, exchange endpoints, and clearing endpoints. The drawing is not decorative; it identifies data flow, module input, module output, state transition, record binding, or routing relationship used by one or more claims.

FIG. 14 mapping. FIG. 14 supports BEI ecosystem interoperability among minting, index, exchange, clearing, wallet, ATMS, time-bank, vault, oracle, and clearing modules. The drawing is not decorative; it identifies data flow, module input, module output, state transition, record binding, or routing relationship used by one or more claims.

### XXVI. PRIOR-ART DISTINCTION AND TECHNICAL FENCES

Distinction over ordinary reward points. The invention differs because the claimed pipeline does not merely credit a user account; it requires identity-bound signing, Admission Gate validation, vault receipt generation, signed index snapshot formation, token metadata binding, domain registry permission verification, and exchange or clearing route assignment. This difference is expressed as concrete processing dependencies and data-structure relationships rather than as an intended business result.

Distinction over ordinary NFT minting. The invention differs because the claimed pipeline does not merely mint a digital collectible; it prevents metadata completion unless signature hash, vault identifier, signed index snapshot, and user domain identifier are mutually consistent. This difference is expressed as concrete processing dependencies and data-structure relationships rather than as an intended business result.

Distinction over ordinary blockchain logging. The invention differs because the claimed pipeline does not merely write an event to a ledger; it generates separate but linked data objects for event, signature, gate state, vault receipt, snapshot, metadata, registry route, and clearing receipt. This difference is expressed as concrete processing dependencies and data-structure relationships rather than as an intended business result.

Distinction over ordinary wallet identity. The invention differs because the claimed registry is not limited to a wallet address; it maps a domain or namespace identifier to minting, vault, governance, index, exchange, time-bank, and clearing permissions. This difference is expressed as concrete processing dependencies and data-structure relationships rather than as an intended business result.

Distinction over ordinary reputation scoring. The invention differs because the claimed BEI index snapshot is not a general score; it is a signed snapshot bound to a policy version, time window, vault identifier, and signature hash. This difference is expressed as concrete processing dependencies and data-structure relationships rather than as an intended business result.

Distinction over ordinary exchange listing. The invention differs because the claimed route engine does not simply list an asset; it consumes signed metadata, registry permissions, index snapshot state, and clearing-route conditions before generating a route status or receipt. This difference is expressed as concrete processing dependencies and data-structure relationships rather than as an intended business result.

Distinction over ordinary database audit logs. The invention differs because the claimed audit trail is not a detached log; it is an ordered set of upstream and downstream identifiers consumed by processor modules before minting and clearing operations. This difference is expressed as concrete processing dependencies and data-structure relationships rather than as an intended business result.

Distinction over ordinary access control. The invention differs because the claimed Admission Gate validates behavior-specific, time-specific, consent-specific, issuer-specific, policy-specific, and registry-specific conditions before completing asset creation. This difference is expressed as concrete processing dependencies and data-structure relationships rather than as an intended business result.

### XXVII. MODULE-SPECIFIC FAILURE AND RECOVERY STATES

Behavioral Event Interface failure states. The Behavioral Event Interface may detect missing required field, malformed evidence commitment, unsupported behavior category, unsupported time window, or conflicting consent scope. The module may output a failure code, quarantine state, pending review state, downgraded route, audit-only state, or exception receipt according to the applicable policy bundle.

Behavioral Event Interface recovery. Recovery may include re-signing, re-vaulting, source re-attestation, policy-version update, registry correction, endpoint rotation, clearing route change, manual review, or generation of a corrected receipt. Recovery preserves prior audit objects rather than deleting the original state.

TransferKey SDK failure states. The TransferKey SDK may detect invalid identity key, expired key version, signature mismatch, domain binding failure, stale nonce, or unsupported signature algorithm. The module may output a failure code, quarantine state, pending review state, downgraded route, audit-only state, or exception receipt according to the applicable policy bundle.

TransferKey SDK recovery. Recovery may include re-signing, re-vaulting, source re-attestation, policy-version update, registry correction, endpoint rotation, clearing route change, manual review, or generation of a corrected receipt. Recovery preserves prior audit objects rather than deleting the original state.

Admission Gate failure states. The Admission Gate may detect duplicated event identifier, consumed signature hash, unauthorized issuer, expired policy version, missing consent, failed source integrity, or exceeded mint cap. The module may output a failure code, quarantine state, pending review state, downgraded route, audit-only state, or exception receipt according to the applicable policy bundle.

Admission Gate recovery. Recovery may include re-signing, re-vaulting, source re-attestation, policy-version update, registry correction, endpoint rotation, clearing route change, manual review, or generation of a corrected receipt. Recovery preserves prior audit objects rather than deleting the original state.

Encrypted Behavioral Vault failure states. The Encrypted Behavioral Vault may detect payload encryption failure, commitment mismatch, vault access denial, revocation state, retention violation, or receipt hash mismatch. The module may output a failure code, quarantine state, pending review state, downgraded route, audit-only state, or exception receipt according to the applicable policy bundle.

Encrypted Behavioral Vault recovery. Recovery may include re-signing, re-vaulting, source re-attestation, policy-version update, registry correction, endpoint rotation, clearing route change, manual review, or generation of a corrected receipt. Recovery preserves prior audit objects rather than deleting the original state.

BEI Index Snapshot Engine failure states. The BEI Index Snapshot Engine may detect policy coefficient unavailable, oracle signature invalid, anomaly threshold exceeded, unsupported category weight, or snapshot signing failure. The module may output a failure code, quarantine state, pending review state, downgraded route, audit-only state, or exception receipt according to the applicable policy bundle.

BEI Index Snapshot Engine recovery. Recovery may include re-signing, re-vaulting, source re-attestation, policy-version update, registry correction, endpoint rotation, clearing route change, manual review, or generation of a corrected receipt. Recovery preserves prior audit objects rather than deleting the original state.

Minting Engine failure states. The Minting Engine may detect missing vault identifier, missing signature hash, missing signed snapshot, inconsistent user domain identifier, blocked transfer mode, or incomplete metadata. The module may output a failure code, quarantine state, pending review state, downgraded route, audit-only state, or exception receipt according to the applicable policy bundle.

Minting Engine recovery. Recovery may include re-signing, re-vaulting, source re-attestation, policy-version update, registry correction, endpoint rotation, clearing route change, manual review, or generation of a corrected receipt. Recovery preserves prior audit objects rather than deleting the original state.

Domain Identity Registry failure states. The Domain Identity Registry may detect revoked domain control, stale endpoint record, missing route permission, unauthorized governance role, or unsigned registry entry. The module may output a failure code, quarantine state, pending review state, downgraded route, audit-only state, or exception receipt according to the applicable policy bundle.

Domain Identity Registry recovery. Recovery may include re-signing, re-vaulting, source re-attestation, policy-version update, registry correction, endpoint rotation, clearing route change, manual review, or generation of a corrected receipt. Recovery preserves prior audit objects rather than deleting the original state.

Exchange or Clearing Routing Engine failure states. The Exchange or Clearing Routing Engine may detect inactive exchange route, blocked time-bank route, invalid clearing member, unsupported netting window, reconciliation mismatch, or exception status. The module may output a failure code, quarantine state, pending review state, downgraded route, audit-only state, or exception receipt according to the applicable policy bundle.

Exchange or Clearing Routing Engine recovery. Recovery may include re-signing, re-vaulting, source re-attestation, policy-version update, registry correction, endpoint rotation, clearing route change, manual review, or generation of a corrected receipt. Recovery preserves prior audit objects rather than deleting the original state.

### XXVIII. FIELD-SPECIFIC CLAIM SUPPORT EXAMPLES

Medical and preventive health example. In the medical and preventive health field, biometric metadata and consent-scoped vault storage permit a non-diagnostic behavior asset to be created while raw health data remain encrypted. The same claimed pipeline remains present: signed event, Admission Gate, vault receipt, signed index snapshot, mint metadata, domain registry permission, and route or clearing receipt.

Education and certification example. In the education and certification field, institutional issuer authorization and category weights permit a skill-completion event to generate a signed index snapshot and clearing-ready scholarship or service unit. The same claimed pipeline remains present: signed event, Admission Gate, vault receipt, signed index snapshot, mint metadata, domain registry permission, and route or clearing receipt.

Eldercare and family service example. In the eldercare and family service field, time-window identifiers and time-bank routing permit caregiving events to be deposited, offset, redeemed, or reconciled through household or institutional nodes. The same claimed pipeline remains present: signed event, Admission Gate, vault receipt, signed index snapshot, mint metadata, domain registry permission, and route or clearing receipt.

Green contribution and climate action example. In the green contribution and climate action field, environmental event attestations may be signed, indexed, capped, and routed to impact indexes or community treasury endpoints. The same claimed pipeline remains present: signed event, Admission Gate, vault receipt, signed index snapshot, mint metadata, domain registry permission, and route or clearing receipt.

Professional guild and labor contribution example. In the professional guild and labor contribution field, guild-authorized source keys and registry-defined route permissions may control whether a professional contribution is internal-only, transferable, or clearing-eligible. The same claimed pipeline remains present: signed event, Admission Gate, vault receipt, signed index snapshot, mint metadata, domain registry permission, and route or clearing receipt.

Emergency response example. In the emergency response field, anomaly or high-priority flags may route a volunteer or disaster event to restricted clearing and later reconciliation without immediate public transferability. The same claimed pipeline remains present: signed event, Admission Gate, vault receipt, signed index snapshot, mint metadata, domain registry permission, and route or clearing receipt.

Governance and policy calibration example. In the governance and policy calibration field, domain-controlled registry permissions may limit governance participation to policy voting, index calibration review, listing review, or clearing-route authorization. The same claimed pipeline remains present: signed event, Admission Gate, vault receipt, signed index snapshot, mint metadata, domain registry permission, and route or clearing receipt.

Cross-border service units example. In the cross-border service units field, policy bundle and registry checks may block or permit cross-jurisdiction routing according to endpoint signatures, route classes, and clearing receipt fields. The same claimed pipeline remains present: signed event, Admission Gate, vault receipt, signed index snapshot, mint metadata, domain registry permission, and route or clearing receipt.

Inheritance and long-term vaults example. In the inheritance and long-term vaults field, separate viewing, signing, transfer, governance, and settlement rights enable multi-generation delegation without exposing private event payloads. The same claimed pipeline remains present: signed event, Admission Gate, vault receipt, signed index snapshot, mint metadata, domain registry permission, and route or clearing receipt.

White-label sdk licensing example. In the white-label SDK licensing field, third-party applications may invoke TransferKey signing and vault commitment functions while BEI index and clearing identifiers remain interoperable. The same claimed pipeline remains present: signed event, Admission Gate, vault receipt, signed index snapshot, mint metadata, domain registry permission, and route or clearing receipt.

### XXIX. PRIVACY, CONSENT, AND SELECTIVE DISCLOSURE DETAILS

Raw payload encryption. The system may implement raw payload encryption so that raw behavior payloads may be encrypted at rest and in transit while token metadata exposes only commitments and identifiers. This allows asset formation and clearing readiness to coexist with privacy-preserving auditability.

Field-level encryption. The system may implement field-level encryption so that sensitive fields such as biometric metadata, emotional metadata, location approximation, or institutional context may be encrypted separately from non-sensitive routing fields. This allows asset formation and clearing readiness to coexist with privacy-preserving auditability.

Hash-only settlement. The system may implement hash-only settlement so that a clearing endpoint may reconcile an asset using vaultId, receiptHash, snapshotIndex, mintTxHash, and reconciliationHash without receiving the raw behavioral payload. This allows asset formation and clearing readiness to coexist with privacy-preserving auditability.

Selective disclosure. The system may implement selective disclosure so that a user, vault, issuer, or auditor may disclose only those fields needed to prove compliance with a policy bundle. This allows asset formation and clearing readiness to coexist with privacy-preserving auditability.

Revocation flags. The system may implement revocation flags so that a registry, vault, or policy bundle may mark a permission, endpoint, key, route, or transfer mode as revoked while preserving historical receipts. This allows asset formation and clearing readiness to coexist with privacy-preserving auditability.

Retention classes. The system may implement retention classes so that different behavior categories may be assigned different retention periods, vault classes, audit permissions, and deletion or sealing rules. This allows asset formation and clearing readiness to coexist with privacy-preserving auditability.

Jurisdiction-specific policy windows. The system may implement jurisdiction-specific policy windows so that a time window, consent scope, or route class may be selected according to jurisdiction profile without changing the core pipeline. This allows asset formation and clearing readiness to coexist with privacy-preserving auditability.

Audit role separation. The system may implement audit role separation so that auditors may verify commitments, signatures, policy versions, and receipts without receiving signing authority or transfer authority. This allows asset formation and clearing readiness to coexist with privacy-preserving auditability.

Privacy-preserving aggregation. The system may implement privacy-preserving aggregation so that the index engine or oracle may aggregate behavior-value ratios without revealing individual raw events. This allows asset formation and clearing readiness to coexist with privacy-preserving auditability.

Consent-scope propagation. The system may implement consent-scope propagation so that a consent scope recorded at capture may be propagated into vault receipts, index snapshots, mint metadata, registry decisions, and clearing receipts. This allows asset formation and clearing readiness to coexist with privacy-preserving auditability.

### XXX. COMPUTER-READABLE MEDIUM AND PROCESSOR EXECUTION SUPPORT

Processor instruction for receive a behavioral event object. A non-transitory computer-readable medium may store instructions that cause one or more processors to receive a behavioral event object, alone or in combination with the other ordered steps described herein. The instruction contributes to the enforceable pipeline by producing or consuming a defined machine-readable object.

Processor instruction for validate required event fields. A non-transitory computer-readable medium may store instructions that cause one or more processors to validate required event fields, alone or in combination with the other ordered steps described herein. The instruction contributes to the enforceable pipeline by producing or consuming a defined machine-readable object.

Processor instruction for generate or consume a nonce. A non-transitory computer-readable medium may store instructions that cause one or more processors to generate or consume a nonce, alone or in combination with the other ordered steps described herein. The instruction contributes to the enforceable pipeline by producing or consuming a defined machine-readable object.

Processor instruction for bind the event to a user identity key and user domain identifier. A non-transitory computer-readable medium may store instructions that cause one or more processors to bind the event to a user identity key and user domain identifier, alone or in combination with the other ordered steps described herein. The instruction contributes to the enforceable pipeline by producing or consuming a defined machine-readable object.

Processor instruction for generate a TransferKey signature hash. A non-transitory computer-readable medium may store instructions that cause one or more processors to generate a TransferKey signature hash, alone or in combination with the other ordered steps described herein. The instruction contributes to the enforceable pipeline by producing or consuming a defined machine-readable object.

Processor instruction for execute Admission Gate states. A non-transitory computer-readable medium may store instructions that cause one or more processors to execute Admission Gate states, alone or in combination with the other ordered steps described herein. The instruction contributes to the enforceable pipeline by producing or consuming a defined machine-readable object.

Processor instruction for store an encrypted payload or commitment in a behavioral vault. A non-transitory computer-readable medium may store instructions that cause one or more processors to store an encrypted payload or commitment in a behavioral vault, alone or in combination with the other ordered steps described herein. The instruction contributes to the enforceable pipeline by producing or consuming a defined machine-readable object.

Processor instruction for obtain a vault identifier and receipt hash. A non-transitory computer-readable medium may store instructions that cause one or more processors to obtain a vault identifier and receipt hash, alone or in combination with the other ordered steps described herein. The instruction contributes to the enforceable pipeline by producing or consuming a defined machine-readable object.

Processor instruction for load a signed policy bundle. A non-transitory computer-readable medium may store instructions that cause one or more processors to load a signed policy bundle, alone or in combination with the other ordered steps described herein. The instruction contributes to the enforceable pipeline by producing or consuming a defined machine-readable object.

Processor instruction for generate a signed BEI index snapshot. A non-transitory computer-readable medium may store instructions that cause one or more processors to generate a signed BEI index snapshot, alone or in combination with the other ordered steps described herein. The instruction contributes to the enforceable pipeline by producing or consuming a defined machine-readable object.

Processor instruction for verify mutual consistency among upstream identifiers. A non-transitory computer-readable medium may store instructions that cause one or more processors to verify mutual consistency among upstream identifiers, alone or in combination with the other ordered steps described herein. The instruction contributes to the enforceable pipeline by producing or consuming a defined machine-readable object.

Processor instruction for create token metadata. A non-transitory computer-readable medium may store instructions that cause one or more processors to create token metadata, alone or in combination with the other ordered steps described herein. The instruction contributes to the enforceable pipeline by producing or consuming a defined machine-readable object.

Processor instruction for resolve registry permissions. A non-transitory computer-readable medium may store instructions that cause one or more processors to resolve registry permissions, alone or in combination with the other ordered steps described herein. The instruction contributes to the enforceable pipeline by producing or consuming a defined machine-readable object.

Processor instruction for route the asset to an endpoint. A non-transitory computer-readable medium may store instructions that cause one or more processors to route the asset to an endpoint, alone or in combination with the other ordered steps described herein. The instruction contributes to the enforceable pipeline by producing or consuming a defined machine-readable object.

Processor instruction for generate a clearing receipt or reconciliation hash. A non-transitory computer-readable medium may store instructions that cause one or more processors to generate a clearing receipt or reconciliation hash, alone or in combination with the other ordered steps described herein. The instruction contributes to the enforceable pipeline by producing or consuming a defined machine-readable object.

Processor instruction for write failure codes or quarantine states. A non-transitory computer-readable medium may store instructions that cause one or more processors to write failure codes or quarantine states, alone or in combination with the other ordered steps described herein. The instruction contributes to the enforceable pipeline by producing or consuming a defined machine-readable object.

### XXXI. BEST-MODE STYLE IMPLEMENTATION WITHOUT LIMITATION

Capture layer. In a preferred but non-limiting implementation, the capture layer uses a canonical JSON object for behavioral events and validates field presence before signing. Alternative implementations may use equivalent data structures, transport protocols, ledgers, databases, or cryptographic primitives while preserving the ordered relationships.

Signing layer. In a preferred but non-limiting implementation, the signing layer uses hardware-backed or wallet-backed identity keys and records publicKeyId and domainBindingHash. Alternative implementations may use equivalent data structures, transport protocols, ledgers, databases, or cryptographic primitives while preserving the ordered relationships.

Gate layer. In a preferred but non-limiting implementation, the gate layer stores gate decisions in a table or append-only stream with passFlag, failureCode, policyRule, and timestamp. Alternative implementations may use equivalent data structures, transport protocols, ledgers, databases, or cryptographic primitives while preserving the ordered relationships.

Vault layer. In a preferred but non-limiting implementation, the vault layer stores encrypted payloads off-chain and anchors receipt hashes to a tamper-evident log. Alternative implementations may use equivalent data structures, transport protocols, ledgers, databases, or cryptographic primitives while preserving the ordered relationships.

Index layer. In a preferred but non-limiting implementation, the index layer uses signed policy bundles and oracle signatures to produce frozen snapshotIndex records. Alternative implementations may use equivalent data structures, transport protocols, ledgers, databases, or cryptographic primitives while preserving the ordered relationships.

Mint layer. In a preferred but non-limiting implementation, the mint layer creates metadata only when userDomain, vaultId, signatureHash, snapshotIndex, policyVersion, and mintTxHash are present. Alternative implementations may use equivalent data structures, transport protocols, ledgers, databases, or cryptographic primitives while preserving the ordered relationships.

Registry layer. In a preferred but non-limiting implementation, the registry layer publishes signed endpoint records for proof, policy, mint, index, exchange, time bank, governance, and clearing roles. Alternative implementations may use equivalent data structures, transport protocols, ledgers, databases, or cryptographic primitives while preserving the ordered relationships.

Routing layer. In a preferred but non-limiting implementation, the routing layer sends assets to exchange, time-bank, governance, or clearing endpoints according to registry permissions and policy bundle conditions. Alternative implementations may use equivalent data structures, transport protocols, ledgers, databases, or cryptographic primitives while preserving the ordered relationships.

Clearing layer. In a preferred but non-limiting implementation, the clearing layer generates clearingReceiptHash and reconciliationHash linked to mintTxHash and vaultId. Alternative implementations may use equivalent data structures, transport protocols, ledgers, databases, or cryptographic primitives while preserving the ordered relationships.

Audit layer. In a preferred but non-limiting implementation, the audit layer allows selective proof of pipeline integrity without public disclosure of raw behavior data. Alternative implementations may use equivalent data structures, transport protocols, ledgers, databases, or cryptographic primitives while preserving the ordered relationships.

The system therefore protects the ordered genesis layer for behavioral assets without requiring a particular blockchain, token standard, domain provider, exchange venue, or clearinghouse implementation.

The foregoing implementation classes are functionally equivalent when they preserve the required machine-readable linkage among signature hash, vault identifier, signed index snapshot, user domain identifier, mint transaction hash, and route or clearing receipt.

The tokenized behavioral asset may be implemented as an NFT, fungible token, time-denominated credit, service unit, ledger entry, account-bound unit, database record, claim object, or settlement-recognized digital asset.

The signed index snapshot may be used for route eligibility, reference quotation, time-bank conversion, service-unit redemption, governance weighting, clearing classification, or privacy-preserving audit without requiring disclosure of raw behavioral payloads.

In a preferred implementation, the same policy version and time-window identifier are propagated from the behavioral event object through the signature object, gate state record, vault receipt, index snapshot, mint metadata, and clearing receipt, thereby preventing mixed-version asset creation and reducing replay, repricing, and route-hijack risk.

The minting engine may refuse to record a mint transaction hash unless an Admission Gate pass state, a vault receipt hash, a snapshot hash for the signed BEI index snapshot, and a domain registry route permission are jointly verified under the same policy version and time-window identifier.

### XXXI. FINAL CLAIM-FOCUSED TECHNICAL GUARDRAILS

### CONCLUSION

The foregoing embodiments are illustrative and are not intended to limit the scope of the claims. Features described in one embodiment may be combined with features of another embodiment unless technically inconsistent.

No particular public blockchain, cryptocurrency, legal-tender unit, commercial domain string, brand, jurisdiction, user interface, or token standard is required. The technical contribution lies in the ordered transformation and evidentiary binding of behavioral events into auditable digital assets suitable for signed index snapshot generation and exchange or clearing route processing.

The claims define the protected scope.

1. A computer-implemented system for minting an auditable behavioral digital asset, the system comprising: (a) a behavioral event interface configured to receive a behavioral event object comprising an event identifier, a timestamp, a time-window identifier, a behavior category, a context field, a consent scope, and an evidence commitment; (b) an identity-bound TransferKey software development kit configured to generate a cryptographic signature hash over the behavioral event object using a user identity key associated with a user domain identifier; (c) an Admission Gate state machine configured to validate at least nonce uniqueness, time-window eligibility, consent scope, issuer authorization, and policy-version eligibility before the behavioral event object is permitted to be minted; (d) an encrypted behavioral vault configured to store an encrypted payload or commitment corresponding to the behavioral event object and to return a vault identifier and receipt hash; (e) a BEI index snapshot engine configured to generate, using at least the signature hash, vault identifier, behavior category, time-window identifier, and policy version, a signed index snapshot representing a behavior-value state for the behavioral event object; (f) a minting engine configured to generate token metadata comprising the user domain identifier, vault identifier, signature hash, signed index snapshot, policy version, consent scope, and mint transaction hash; (g) a domain identity registry configured to associate the user domain identifier with minting permissions, vault access permissions, governance permissions, index calibration permissions, and exchange or clearing route permissions; and (h) an exchange or clearing routing engine configured to route the token metadata to an exchange endpoint, time-bank endpoint, governance endpoint, or clearing endpoint based on the signed index snapshot and the domain identity registry, wherein the minting engine is prevented from completing the token metadata unless the signature hash, vault identifier, signed index snapshot, and user domain identifier are verified as mutually consistent, and wherein no mint transaction hash is recorded unless an Admission Gate pass state, the receipt hash, a snapshot hash of the signed index snapshot, and a domain registry route permission are jointly verified under a same policy version and time-window identifier.

2. The system of claim 1, wherein the behavioral event object further comprises biometric metadata selected from heart rate, breathing rate, galvanic skin response, temperature, motion, impedance, optical signal, acoustic signal, or a combination thereof.

3. The system of claim 1, wherein the behavioral event object further comprises an emotionSeal field representing a bounded emotional-state classification or commitment that is stored as metadata and is not used as an unconstrained monetary value.

4. The system of claim 1, wherein the TransferKey software development kit exposes one or more application programming interfaces comprising signBehavior, requestVaultCommitment, requestIndexSnapshot, mintBehavioralAsset, validateVault, validateClearingRoute, or a smart contract call interface.

5. The system of claim 1, wherein the encrypted behavioral vault stores detailed behavioral data off-chain while anchoring the receipt hash to a tamper-evident data structure comprising a distributed ledger, permissioned ledger, append-only log, Merkle tree, write-once storage structure, or equivalent integrity-preserving structure.

6. The system of claim 1, wherein the BEI index snapshot engine generates the signed index snapshot using behavior category weights, source confidence, user tier state, anomaly score, time-window weight, oracle state, and policy coefficients defined in a signed policy bundle.

7. The system of claim 1, wherein the signed index snapshot comprises an index version, effective time, time-window identifier, policy-version identifier, category weight, source score, anomaly flag, oracle signature, and snapshot hash.

8. The system of claim 1, wherein the exchange or clearing routing engine dynamically recalibrates listing eligibility or price quotation by referencing aggregated behavior-value ratios from a sovereign oracle while preserving the signed index snapshot associated with the minted behavioral digital asset.

9. The system of claim 1, wherein the domain identity registry is implemented using a domain name, subdomain, decentralized domain, DID-style identifier, account-bound token, non-transferable identity token, or namespace basepoint mapped to signed endpoint records.

10. The system of claim 1, wherein verified ownership or control of a domain token grants one or more governance rights limited to policy voting, index calibration review, vault access delegation, exchange listing review, or clearing-route authorization.

11. A computer-implemented method for converting a behavioral event into an auditable behavioral digital asset, the method comprising: receiving a behavioral event object including an event identifier, timestamp, time-window identifier, behavior category, context field, consent scope, and evidence commitment; generating, by an identity-bound TransferKey software development kit, a cryptographic signature hash over the behavioral event object using a user identity key associated with a user domain identifier; validating, by an Admission Gate state machine, nonce uniqueness, time-window eligibility, consent scope, issuer authorization, and policy-version eligibility; storing, by an encrypted behavioral vault, an encrypted payload or commitment corresponding to the behavioral event object and returning a vault identifier and receipt hash; generating, by a BEI index snapshot engine, a signed index snapshot using at least the signature hash, vault identifier, behavior category, time-window identifier, and policy version; jointly verifying an Admission Gate pass state, the receipt hash, a snapshot hash of the signed index snapshot, and a domain registry route permission under a same policy version and time-window identifier before recording a mint transaction hash; generating, by a minting engine, token metadata comprising the user domain identifier, vault identifier, signature hash, signed index snapshot, policy version, consent scope, and mint transaction hash; associating, by a domain identity registry, the user domain identifier with minting permissions, vault access permissions, governance permissions, index calibration permissions, and exchange or clearing route permissions; and routing, by an exchange or clearing routing engine, the token metadata to an exchange endpoint, time-bank endpoint, governance endpoint, or clearing endpoint based on the signed index snapshot and domain identity registry.

12. The method of claim 11, further comprising generating a clearing receipt comprising a settlement batch identifier, netting window, counterparty route, clearing endpoint identifier, route status, reconciliation hash, and clearing receipt hash.

13. The method of claim 11, further comprising denying minting when the Admission Gate state machine detects a stale time window, duplicated nonce, missing consent scope, unauthorized issuer, inconsistent policy version, or previously consumed signature hash.

14. The method of claim 11, further comprising generating a failure code when the behavioral event object is incomplete, corrupted, replayed, outside an effective policy window, inconsistent with a registry permission, or ineligible for exchange routing.

15. The method of claim 11, further comprising recalibrating, by the BEI index snapshot engine, one or more value indexes based on aggregated multi-user behavior patterns while retaining the signed index snapshot created for a particular minted behavioral digital asset.

16. The method of claim 11, further comprising routing a time-denominated behavioral digital asset to a time-bank node for deposit, redemption, offset, service-unit settlement, or reconciliation according to a policy-defined time window.

17. The method of claim 11, further comprising initiating an alert protocol or quarantine status when a behavioral anomaly spike exceeds a policy-defined threshold without automatically minting a transferable asset.

18. The method of claim 11, further comprising configuring inheritance delegation for an encrypted behavioral vault by separating viewing rights, signing rights, transfer rights, governance rights, and settlement rights.

19. The method of claim 11, wherein the exchange or clearing routing engine maps the token metadata to a clearing receipt and updates the encrypted behavioral vault with a reconciliation hash linked to the mint transaction hash.

20. A non-transitory computer-readable medium storing instructions that, when executed by one or more processors, cause the one or more processors to: receive a behavioral event object comprising an event identifier, timestamp, time-window identifier, behavior category, context field, consent scope, and evidence commitment; generate, through an identity-bound TransferKey software development kit, a cryptographic signature hash over the behavioral event object using a user identity key associated with a user domain identifier; validate nonce uniqueness, time-window eligibility, consent scope, issuer authorization, and policy-version eligibility through an Admission Gate state machine; store an encrypted payload or commitment corresponding to the behavioral event object in an encrypted behavioral vault and obtain a vault identifier and receipt hash; generate a signed BEI index snapshot using at least the signature hash, vault identifier, behavior category, time-window identifier, and policy version; verify, before recording a mint transaction hash, that an Admission Gate pass state, the receipt hash, a snapshot hash of the signed BEI index snapshot, and a domain registry route permission are jointly valid under a same policy version and time-window identifier; generate token metadata comprising the user domain identifier, vault identifier, signature hash, signed BEI index snapshot, policy version, consent scope, and mint transaction hash; associate the user domain identifier with registry-defined minting permissions, vault access permissions, governance permissions, index calibration permissions, and exchange or clearing route permissions; and route the token metadata to an exchange endpoint, time-bank endpoint, governance endpoint, or clearing endpoint based on the signed BEI index snapshot and the registry-defined permissions.
